(19) United States
(12) Patent Application Publication
(10) Pub. No.: US 2026/0357153 A1
(43) Pub. Date: Nov. 12, 2026

(54) DETERGENT AND/OR CLEANING COMPOSITIONS FOR MALODOR REDUCTION AND FRAGRANCE BOOST

(71) Applicant: SYMRISE AG, Holzminden (DE)

(72) Inventors: Tony BARTOLINI, Herblay-sur-Seine (FR); Anne-Laure AZAIS, Poissy (FR)

(21) Appl. No.: 19/123,856

(22) PCT Filed: Oct. 25, 2023
(86) PCT No.: PCT/EP2023/079720

§ 371 Date: Apr. 24, 2025

(30) Foreign Application Priority Data
Oct. 25, 2022 (WO) PCT/EP2022/079776

(51) Int. Cl. C11D 3/00; C11D 1/14; C11D 1/22; C11D 1/72; C11D 1/83; C11D 3/20; C11D 3/48; C11D 3/50

(52) U.S. Cl. CPC C11D 3/0068; C11D 1/83; C11D 3/0015; C11D 3/2044; C11D 3/2065; C11D 3/2072; C11D 3/2093; C11D 3/48; C11D 3/50; C11D 1/143; C11D 1/146; C11D 1/22; C11D 1/72

(57) ABSTRACT

The present invention refers generally to the field of detergent and/or cleaning compositions. In particular, it relates to detergent and/or cleaning compositions comprising specific mixtures of hydroxyl compounds and having improved fragrance performance. More specifically, the present invention relates to detergent and/or cleaning compositions that comprise a surfactant, an odorous substance, an effective amount of a combination of alkanediols and glyceryl caprylate, 4-hydroxyacetophenone, and/or ethyl hexyl glycerin and optionally an antimicrobial component, and the use of said detergent and/or cleaning compositions for the preparation of a detergent and/or cleaning preparation/product for household, institutional and industrial application. Additionally, the present invention relates to the use of a combination of specific substances as defined herein for boosting the cleaning efficiency of a detergent and/or cleaning composition and/or boosting the olfactory properties of odorous substances and/or for boosting the adherence of odorous substances and/or malodor reduction and/or malodor coverage and/or for malodor prevention. Finally, the present invention relates to a method for boosting the cleaning efficiency of a detergent and/or cleaning composition and/or boosting the olfactory properties of odorous substances and/or for boosting the adherence of odorous substances and/or malodor reduction and/or malodor coverage by adding an effective amount of a combination of alkanediols and glyceryl caprylate, 4-hydroxyacetophenone, and/or ethyl hexyl glycerin as fragrance boosters to said detergent and/or cleaning composition.

### TECHNICAL FIELD

The present invention refers generally to the field of detergent and/or cleaning compositions used in the field of homecare. In particular, it relates to detergent and/or cleaning compositions comprising specific combinations of hydroxyl compounds and having an improved fragrance performance as well as improved malodor reduction/coverage/masking properties.

More specifically, the present invention relates to detergent and/or cleaning compositions that comprise a surfactant, an odorous substance, an effective amount of a mixture of 1,2-heptanediol and/or 2,3-heptanediol or at least one other alkanediol having a carbon chain of 5 to 14 carbon atoms and glyceryl caprylate, 4-hydroxyacetophenone, and/or ethyl hexyl glycerin as fragrance boosters, and optionally an antimicrobial component, and the use of said detergent and/or cleaning compositions for the preparation of a detergent and/or cleaning preparation/product for household, institutional and industrial application. Additionally, the present invention relates to the use of a mixture of 1,2-heptanediol and/or 2,3-heptanediol or at least one other alkanediol having a carbon chain of 5 to 14 carbon atoms as defined herein with glyceryl caprylate, 4-hydroxyacetophenone, and/or ethyl hexyl glycerin for boosting the cleaning efficiency of a detergent and/or cleaning composition and/or boosting the olfactory properties of odorous substances and/or for boosting the adherence of odorous substances and/or for malodor reduction and/or for malodor coverage and/or for malodor prevention. Finally, the present invention relates to a method for boosting the cleaning efficiency of a detergent and/or cleaning composition and/or for boosting the olfactory properties of odorous substances and/or for boosting the adherence of odorous substances and/or for malodor reduction/coverage/prevention by adding an effective amount of a mixture of 1,2-heptanediol and/or 2,3-heptanediol or of other alkanediols having a carbon chain of 5 to 14 carbon atoms as defined herein with glyceryl caprylate, 4-hydroxyacetophenone, and/or ethyl hexyl glycerin as (fragrance) boosting agents to said (perfumed) detergent and/or cleaning composition.

### BACKGROUND ART

Detergent and/or cleaning compositions must remove a wide variety of stains and soils form different substrate types under a broad range of cleaning conditions. Detergents and cleaning compositions, in particular for laundry and textile cleaning, dishwashing and the like are composed predominantly of surfactants or a mixture of surfactants, whose main task is to remove water-insoluble substances like dirt and grease from surfaces such as fabric, clothes, dishes, wares, etc., and hard surfaces such as metals, plastics, glass, ceramics, etc. Other than surfactants, modern detergent and/or cleaning formulations consist of builders, chelating agents, co-builders and other polymer additives used for specific washing or cleaning effects such as soil release and anti-redeposition, dye transfer inhibition and rheology modification. In addition to said ingredients, one or more bleaching agents as a further active substance are usually added to the detergents and cleaning compositions.

Nowadays, for example, many consumer products such as detergents, fabric softeners, washing powders, liquid detergents, shower gels, shampoos, deodorants, lotions, etc. are perfumed with fragrance materials or contain cosmetic ingredients to deliver a specific effect. The detergent and/or cleaning composition should amongst others provide for a fresh scent in order to not only visually but also olfactory perceive the freshness and cleanness after cleaning or washing. Preferably, the detergent and/or cleaning compositions should also provide for an efficient malodor coverage/masking or removal, i.e. the removal or reduction of an odor which is not desired on the corresponding clean items and is rather considered unpleasant. The cleaned item should smell fresh and clean without malodors adhered to the item or alternatively impart a certain desirable fragrance or a sensation of freshness. This sensation of cleanness or freshness is particularly desired for example for laundry detergents, toilet cleaners and the like.

In order to achieve the desired odor impression usually often a plurality of ingredients such as additives and auxiliaries are required, or a high amount of the fragrance component has to be added. Common additives for improving the fragrance impression are so-called fixatives i.e. scent retardants. These substances are usually substances with a low volatility. However, unfortunately these substances and their scent can interfere with the other ingredients of the detergent and/or cleaning formulation thereby altering the desired odor impression of the fragrance component, or the substances can also hinder each other in scent development.

Moreover, homecare products such as laundry detergents (in powdered or liquid form), fabric conditioner, dishwashing detergents, floor and surface cleaners, glass cleaners, air freshers and the like should be able to efficiently reduce the malodor or unpleasant smell such as from human sweats or from animal sweats on home furnishings and textiles such as pillows, sofa covers etc., clothes, carpets, and the like. Additionally, an efficient detergent and/or cleaning composition should prevent the formation of malodor.

Malodorous smells exist in many environments. Such odors are created in industrial, commercial, and residential environments. In industrial environments, the odors are often created by processes involving the use of chemicals. In commercial and residential environments, malodorous odors can be generated by, for example, waste product, trash receptacles, cat litter, sweat, and food handling and processing.

Unfortunately, the plurality of ingredients of these detergent and/or cleaning compositions can interact with each other or might cause allergic reactions upon usage. Additionally, more volatile components of the perfume formulation of such compositions tend to evaporate prematurely. Consequently, this leads to an undesired change and/or decrease of the fragrance impression.

Thus, the detergent industry is permanently searching for ingredients which can resolve these negative aspects.

Thus, there is still an ongoing need for substances with the ability for improving the cleaning and fragrance performance of detergent and/or cleaning compositions containing a fragrance component without requiring a plurality of additional additives.

In addition, there is a need for detergent and/or cleaning compositions which are less complex, highly effective, which avoid the use of unfavorable ingredients under environmental and health aspects.

Accordingly, it is therefore an object of the present invention to provide multi-use detergent and/or cleaning compositions with a superior fragrance performance, and, with an improved cleaning performance. In particular, it is an object of the present invention to provide for a detergent and/or cleaning compositions with an improved fragrance performance in terms of intensity and adherence.

Furthermore, it is an object of the present invention to provide detergent and/or cleaning compositions that provide better cleaning performances along with improved malodor reduction and/or coverage effects compared to detergent and/or cleaning compositions comprising a usual formulation and that additionally prevent the formation of malodor.

Moreover, it is an object of the present invention to provide for a method of cleaning a substrate along with improved olfactory performances in terms of intensity and adherence without requiring additives such as fixatives.

It is another object of the present invention to provide for substances or mixtures of substances, which are capable of boosting the fragrance intensity of an odorous substance in a detergent and/or cleaning composition and of improving the adherence of odorous substances comprised in a detergent and/or cleaning composition even when using small amounts of the fragrance component.

Finally, it is an object of the present invention, to provide a method for boosting or improving the cleaning efficiency of a detergent and/or cleaning composition and/or improving the malodor coverage and/or malodor reduction and/or malodor prevention.

Surprisingly, it has been found that the addition of an effective amount of specific mixtures of 1,2-heptanediol or 2,3-heptanediol or a mixture comprising 1,2-heptanediol and 2,3-heptanediol or at least one other alkanediol as specified herein with at least one further boosting agent such as glyceryl caprylate, 4-hydroxyacetophenone, and/or ethyl hexyl glycerin as fragrance boosters, as defined herein, to a detergent and/or cleaning composition comprising an odorous component, has a positive influence on the cleaning performance and efficiently allows for an improvement of the fragrance impression. Substrates treated with the detergent and/or cleaning compositions according to the present invention show a considerably increased fragrance impression with prolonged adhesion compared to formulations not comprising the mixtures containing 1,2-heptanediol or 2,3-heptanediol or a mixture comprising 1,2-heptanediol and 2,3-heptanediol or of the at least one alkanediol as specified herein with glyceryl caprylate, 4-hydroxyacetophenone, and/or ethyl hexyl glycerin as fragrance boosters. Surprisingly, mixtures of alkanediols with glyceryl caprylate, 4-hydroxyacetophenone, and/or ethyl hexyl glycerin show excellent fragrance boosting properties, i.e. the intensity and the adherence of the fragrances contained in the detergent and/or cleaning compositions is improved even when using small amounts of the fragrance component without requiring the addition of fixatives and the like thereby reducing the overall amount of ingredients in the final formulation and reducing the allergic potential and environmental impact of the final product formulation.

Accordingly, in order to achieve a sufficient adhesion no additional additives are required.

In addition, it was surprisingly found that the compositions disclosed herein can efficiently reduce malodor or at least efficiently cover malodor. Moreover, it was surprisingly found that the compositions disclosed herein can efficiently prevent the formation of malodor. These effects are not merely based on the presence of the odorous component but result from a synergistic interaction of the single components of the composition.

Furthermore, the fragrance boosting component simultaneously improves the cleaning performance so that in total less ingredients are required in order to provide for an efficient detergent and/or cleaning formulation providing for a clean and fresh result and impression.

More specifically, surprisingly, it has been found that the addition of an effective amount of 1,2-heptanediol or 2,3-heptanediol or a mixture comprising 1,2-heptanediol and 2,3-heptanediol or at least one alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol in combination with glyceryl caprylate, 4-hydroxyacetophenone, and/or ethyl hexyl glycerin, as defined herein, to a detergent and/or cleaning composition, improves the fragrance intensity of fragrances in detergent and/or cleaning compositions comprising an odorous component and prolongs their adhesion onto the treated substrates thereby guaranteeing a prolonged scent, compared to detergent and/or cleaning compositions without such a fragrance boosting composition being based on the combination of specific hydroxyl compounds as defined herein.

Thus, the perfumed detergent and/or cleaning compositions which contain a fragrance component in combination with 1,2-heptanediol or 2,3-heptanediol or a mixture comprising 1,2-heptanediol and 2,3-heptanediol or at least one alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol in combination with glyceryl caprylate, 4-hydroxyacetophenone, and/or ethyl hexyl glyceryl, as defined herein, provide for an improved overall performance in terms of cleaning and scent impression over detergent and/or cleaning compositions without such a fragrance boosting composition.

Conversely, also because of the boosting effect in terms of fragrance performance, cleaning performance and malodor reduction/prevention performance, the amount of additives such as fixatives, fragrances, malodor reducers and other ingredients for increasing the efficacy and fragrance performance in these detergent and/or cleaning compositions can be reduced without loss of cleaning performance.

### SUMMARY OF THE INVENTION

The present invention was made in view of the disadvantages described above. To solve the above-mentioned drawbacks, the present invention provides a detergent and/or cleaning composition, that noticeably minimizes or removes malodor or prevents the formation of malodor and simultaneously shows an intense and long-lasting odor performance along with an improved cleaning performance.

In order to accomplish the above problem, the present invention thus provides in an aspect a detergent and/or cleaning composition, comprising or consisting of:
(a1) at least one surfactant;
(b1) at least one odorous substance;
(c1.1) 1,2-heptanediol; and
(c1.2) at least one (fragrance) boosting agent selected from the group consisting of glyceryl caprylate, 4-hydroxyacetophenone, ethyl hexyl glycerin, and any mixtures thereof; and
(d1) optionally at least one antimicrobial compound;
or
(a2) at least one surfactant;
(b2) at least one odorous substance;
(c2.1) 2,3-heptanediol; and
(c2.2) at least one (fragrance) boosting agent selected from the group consisting of glyceryl caprylate, 4-hydroxyacetophenone, ethyl hexyl glycerin, and any mixtures thereof; and
(d2) optionally at least one antimicrobial compound;
or
(a3) at least one surfactant;
(b3) at least one odorous substance;
(c3.1) a mixture comprising 1,2-heptanediol and 2,3-heptanediol; and
(c3.2) at least one (fragrance) boosting agent selected from the group consisting of glyceryl caprylate, 4-hydroxyacetophenone, ethyl hexyl glycerin, and any mixtures thereof; and
(d3) optionally at least one antimicrobial compound,
preferably for boosting the cleaning efficiency of a detergent and/or cleaning composition and/or for boosting the olfactory properties of odorous substances and/or for boosting the adherence of odorous substances and/or for malodor reduction and/or for malodor coverage and/or for malodor prevention.

In another aspect, the present invention provides a detergent and/or cleaning composition, comprising or consisting of:
(a) at least one surfactant;
(b) at least one odorous substance;
(c) a mixture comprising or consisting of
   (c^{I}) at least one (fragrance) boosting agent selected from the group consisting of at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
   and at least one further (fragrance) boosting agent selected from the group consisting of
   (c^{II}) glyceryl caprylate;
   (c^{III}) 4-hydroxyacetophenone;
   (c^{IV}) ethyl hexyl glycerin; and any mixtures of these further (fragrance) boosting agents; and
(d) optionally at least one antimicrobial compound, preferably for boosting the cleaning efficiency of a detergent and/or cleaning composition and/or boosting the olfactory properties of odorous substances and/or for boosting the adherence of odorous substances and/or malodor reduction and/or for malodor coverage and/or for malodor prevention.

In an even more preferred variant, the at least one linear alkanediol, the at least one first linear alkanediol and/or the one or more second linear alkanediol have a carbon chain length of 7 to 14 carbon atoms, and further preferred a carbon chain length from 7 to 12 carbon atoms, more preferred a carbon chain length of 7 to 10 carbon atoms, and most preferred a carbon chain length from 7 to 9 carbon atoms. For these alkanediols particularly pronounced boosting effects were observed, especially in terms of fragrance boosting.

In a further aspect, the present invention provides for the use of the detergent and/or cleaning composition as a detergent and/or cleaning product, or for the preparation of a detergent and/or cleaning product.

In a further aspect, the present invention provides for a detergent and/or cleaning product as such comprising or consisting of the detergent and/or cleaning compositions according to the present invention.

It was surprisingly found that the compositions according to the invention can efficiently be used for boosting the cleaning efficiency of a detergent and/or cleaning composition and/or for boosting the olfactory properties of odorous substances contained therein and/or for boosting the adherence of odorous substances and/or for malodor reduction and/or for malodor coverage and/or for malodor prevention.

In a still further aspect, the present invention provides for the use of a mixture of 1,2-heptanediol or 2,3-heptanediol or a mixture comprising 1,2-heptanediol and 2,3-heptanediol or a mixture (c) comprising or consisting of
(c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
and at least one further boosting agent selected from the group consisting of
(c^{II}) glyceryl caprylate;
(c^{III}) 4-hydroxyacetophenone;
(c^{IV}) ethyl hexyl glycerin; and any mixture of these further boosting agents;

for boosting the cleaning efficiency of a detergent and/or cleaning composition and/or for boosting the olfactory properties of odorous substances and/or for boosting the adherence of odorous substances and/or for malodor reduction and/or for malodor coverage and/or for malodor prevention.

In a more preferred variant, the present invention relates to the use of a mixture (c) comprising or consisting of
(c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;

and at least one further boosting agent selected from the group consisting of
(c^{II}) glyceryl caprylate;
(c^{III}) 4-hydroxyacetophenone;
(c^{IV}) ethyl hexyl glycerin; and
any mixture of these further boosting agents;
for boosting the cleaning efficiency of a detergent and/or cleaning composition and/or for boosting the olfactory properties of odorous substances and/or for boosting the adherence of odorous substances and/or for malodor reduction and/or for malodor coverage and/or for malodor prevention.

In an even more preferred variant, the at least one linear alkanediol, the at least one first linear alkanediol and/or the one or more second linear alkanediol have a carbon chain length of 7 to 14 carbon atoms, and further preferred a carbon chain length from 7 to 12 carbon atoms, more preferred a carbon chain length from 7 to 10 carbon atoms, and most preferred a carbon chain length from 7 to 9 carbon atoms. For these alkanediols particularly pronounced boosting effects were observed, especially in terms of fragrance boosting.

In a final aspect, the present invention provides for a method of boosting or improving the cleaning efficiency of a detergent and/or cleaning composition and/or for boosting the olfactory properties of odorous substances and/or for boosting the adherence of odorous substances and/or for malodor reduction and/or for malodor prevention, comprising the steps of:
(i) providing a detergent and/or cleaning composition comprising at least one surfactant and at least one odorous substance; and
(ii) adding thereto an effective amount of a mixture of 1,2-heptanediol or 2,3-heptanediol or a mixture comprising 1,2-heptanediol and 2,3-heptanediol or a mixture (c) comprising or consisting of
   (c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol; and at least one further boosting agent selected from the group consisting of
   (c^{II}) glyceryl caprylate;
   (c^{III}) 4-hydroxyacetophenone;
   (c^{IV}) ethyl hexyl glycerin; and any mixture of these further boosting agents.

In a more preferred variant, the present invention provides for a method of boosting or improving the cleaning efficiency of a detergent and/or cleaning composition and/or for boosting the olfactory properties of odorous substances and/or for boosting the adherence of odorous substances and/or for malodor reduction and/or for malodor prevention, comprising the steps of:
(i) providing a detergent and/or cleaning composition comprising at least one surfactant and at least one odorous substance; and
(ii) adding thereto an effective amount of a mixture (c) comprising or consisting of
   (c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   and at least one further boosting agent selected from the group consisting of
   (c^{II}) glyceryl caprylate;
   (c^{III}) 4-hydroxyacetophenone;
   (c^{IV}) ethyl hexyl glycerin; and
   any mixture of these further boosting agents.

In an even more preferred variant, the at least one linear alkanediol, the at least one first linear alkanediol and/or the one or more second linear alkanediol have a carbon chain length of 7 to 14 carbon atoms, and further preferred a carbon chain length from 7 to 12 carbon atoms, more preferred a carbon chain length from 7 to 10 carbon atoms, and most preferred a carbon chain length from 7 to 9 carbon atoms. For these alkanediols particularly pronounced boosting effects were observed, especially in terms of fragrance boosting.

The present invention is specified in the appended claims. The invention itself, and its preferred variants, other objects and advantages, are however also apparent from the following detailed description in conjunction with the accompanying examples and figures.

All percentages are by weight unless otherwise indicated.

Numeric ranges recited within the specification and given in the form “x to y” include the values defining the range and include each integer within the defined range. When multiple preferred numeric ranges are specified in this format, all ranges created by combining the various endpoints are also included.

In the context of the present invention, the term “comprising” means that the named components are essential, but other components may be added and is still embraced by the present invention.

The term “consisting of” as used according to the present invention means that the total amount of components (a) to (c) (and (a) to (d) respectively) adds up to 100% by weight, based on the total weight of the detergent and/or cleaning composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

In the context of the present invention, the term “at least one . . . ” or “one or more . . . ” means that the detergent and/or cleaning composition according to the present invention can comprise either one or a mixture of two, three, four, five, six or even more different of the respective components following said term.

The term “and/or” expresses that a linkage exists, or an alternative is provided.

The term “optionally” means that the subsequently described component may but need not to be present in the detergent and/or cleaning composition, and that the description includes variants, where the compound is included or variants, where the compound is absent.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

The term “boosting” in the context of the present invention means “improving”, “enhancing”, “increasing”. Correspondingly, a “boosting agent” or a “boosting composition” is an agent or mixture of substances (composition) capable of “improving”, “enhancing”, “increasing” certain features or properties as defined herein, and in particular the fragrance performance in terms of fragrance intensity and/or fragrance adhesion of an odorous substance in a detergent and/or cleaning composition. Additionally, the boosting agents as specified herein improve the cleaning properties and the malodor coverage/reduction/prevention properties of the detergent and/or cleaning compositions disclosed herein. Accordingly, the term “boosting” is not restricted to the fragrance boosting properties of the corresponding composition.

The term “adhesion” refers to the reminiscence of a fragrance compound (odorous substance) on the substrate it is applied to (also referred to as fixation or tenacity). The slower the fragrance/scent of a perfume dissipates, the more adhesive it is as the adhesion of a fragrance depends on its degree of volatility. Adhesion is usually achieved by means of fixation. The terms “fragrance substance”, “fragrance compound”, “odorous substance” and “odorous compound” and the like are used synonymously.

Surprisingly the compositions according to the present invention are efficient detergent and/or cleaning compositions simultaneously showing improved fixation/tenacity allowing for long-lasting and intense fragrance impressions.

The resulting perfumed formulations/products show even at a low rate of addition of the odorous compound(s) high intensities while simultaneously guaranteeing an enhanced fixation (tenacity).

Numerous attempts have been made to conceal malodors through the use of deodorizing compositions. The odor neutralizing agents function to interact with the malodors and chemically neutralize them. However, these neutralizing agents (such as oxidizing agents such as oxygen bleaches, chlorine; chlorinated materials such as sodium hypochlorite, chlorine dioxide; potassium permanganate; reducing agents such as sodium bisulfite) are usually flammable, explosive, corrosive, or toxic. The odor masking agents function to intentionally conceal odors by the addition of another. Odor masking has been accomplished by using perfumes, fragrances, colognes, etc. Moreover, both the deodorizing agents and neutralizing agents might cause allergic reactions or interact with the other components of the final product.

In general, masking agents suppress the malodor by: (i) providing a more pleasing scent using large quantities of a fragrance; or (ii) providing a fragrance that blends with the malodor to provide a different and more desirable scent. Unfortunately, in both instances, a large amount of fragrance must be utilized, which in itself often proves to be offensive. Furthermore, the malodor is usually still detectable at the levels of masking fragrances that are reasonably tolerable. Additionally, high levels of odorous components are expensive and might cause allergic reactions.

Surprisingly it was found that the compositions disclosed herein are efficient in masking malodor (“malodor coverage”). In order to achieve an efficient coverage only low levels of odorous components are required based on the boosting effect of the (fragrance) boosting agents as specified herein.

Additionally, it was found, that the compositions disclosed herein are efficient in reducing malodor or even preventing the formation of malodor without requiring the addition of harmful or dangerous neutralizing agents. Accordingly, the compositions according to the present invention are not only able to cover or mask malodor but also efficiently prevent the formation of malodor.

### DETAILED DESCRIPTION OF THE INVENTION

In one aspect, the present invention relates to a detergent and/or cleaning composition, comprising or consisting of:
(a1) at least one surfactant;
(b1) at least one odorous substance;
(c1.1) 1,2-heptanediol; and (c1.2) at least one (fragrance) boosting agent selected from the group consisting of glyceryl caprylate, 4-hydroxyacetophenone, ethyl hexyl glycerin, and any mixtures thereof; and
(d1) optionally at least one antimicrobial compound.

Alternatively, the present invention relates in one aspect to a detergent and/or cleaning composition, comprising or consisting of:
(a2) at least one surfactant;
(b2) at least one odorous substance;
(c2.1) 2,3-heptanediol; and
(c2.2) at least one (fragrance) boosting agent selected from the group consisting of glyceryl caprylate, 4-hydroxyacetophenone, ethyl hexyl glycerin, and any mixtures thereof; and
(d2) optionally at least one antimicrobial compound.

In a further alternative, the present invention relates in one aspect to a detergent and/or cleaning composition, comprising or consisting of:
(a3) at least one surfactant;
(b3) at least one odorous substance;
(c3.1) a mixture comprising 1,2-heptanediol and 2,3-heptanediol; and
(c3.2) at least one (fragrance) boosting agent selected from the group consisting of glyceryl caprylate, 4-hydroxyacetophenone, ethyl hexyl glycerin, and any mixtures thereof;
and
(d3) optionally at least one antimicrobial compound.

Preferably, said composition is used for boosting or improving the cleaning efficiency of a detergent and/or cleaning composition and/or for boosting the olfactory properties of odorous substances and/or for boosting the adherence of odorous substances and/or for malodor reduction and/or for malodor coverage and/or for malodor prevention.

In a further aspect, the present invention relates to a detergent and/or cleaning composition, comprising or consisting of:
(a) at least one surfactant;
(b) at least one odorous substance;
(c) a mixture comprising or consisting of:
   (c^{I}) at least one (fragrance) boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   and at least one further (fragrance) boosting agent selected from the group consisting of
   (c^{II}) glyceryl caprylate;
   (c^{II}) 4-hydroxyacetophenone;
   (c^{IV}) ethyl hexyl glycerin; and any mixture of these further boosting agents; and
(d) optionally at least one antimicrobial compound.

In an even more preferred variant, the at least one linear alkanediol, the at least one first linear alkanediol and/or the one or more second linear alkanediol have a carbon chain length of 7 to 14 carbon atoms, and further preferred a carbon chain length from 7 to 12 carbon atoms, more preferred a carbon chain length from 7 to 10 carbon atoms, and most preferred a carbon chain length from 7 to 9 carbon atoms. For these alkanediols particularly pronounced boosting effects were observed.

Accordingly, the detergent and/or cleaning composition according to the present invention comprises a (first) boosting component (c) that is based on a boosting mixture (c) of at least one first alkanediol component ((first) boosting agent/component) as specified above and at least one further or second component (further or second boosting agent/component) selected from the group consisting of glyceryl caprylate, 4-hydroxyacetophenone, ethyl hexyl glycerin, or any mixture of these further boosting agents.

The term “detergent and/or cleaning composition” as contemplated herein, is understood to mean all products that are suitable and commonly used for washing or cleaning. Detergent and/or cleaning compositions are composed predominantly of surfactants or a mixture of surfactants. Other than surfactants, the detergent and/or cleaning compositions normally consist of builders and chelating agents, co-builders and other polymeric additives used for specific effects such as anti-redeposition, dye transfer inhibition, or rheology modification. Detergent and/or cleaning compositions refer to compositions that find use in the removal of undesired compounds from items to be cleaned, such as textiles (such as fabrics, clothes), dishes, floors, hard surfaces (such as metals, plastics and ceramics). These deposits might be caused by stains and soils, germs and other contaminants. Detergents are the most commonly used cleaning compositions for textiles. The detergent and/or cleaning compositions may be used for household cleaning, institutional cleaning, and industrial cleaning. The detergent and/or cleaning compositions also include disinfectants that kill all vegetative cells including recognized pathogenic microorganisms. The detergent and/or cleaning compositions can be used by the detergent composition itself or by a detergent product or by a use solution thereof.

The detergent and/or cleaning compositions according to the present invention are preferably used for removing stains and/or soils from textile, fabrics, laundry, dishes, ware, medical and dental instruments, hard surfaces, etc. while simultaneously boosting or improving the olfactory impression and/or for boosting the adherence of odorous substances and/or malodor reduction/coverage/prevention.

The detergent and/or cleaning compositions according to the present invention provide for both improved cleaning performances and improved olfactory properties along with a reduction of malodor and/or malodor coverage and/or malodor prevention.

Within the scope of the present invention the terms “cleaning” and “washing” are used synonymously and refer to the reduction and/or removal of deposits, i.e. the removal of undesired compounds from items/substrates to be cleaned such as textiles and surfaces, on tableware/dishes and other kitchen utensils such as cutlery/silverware, pots, pans, bakeware and the like as well as other substrates.

These deposits might be formed by stains caused by sweat, grease, tea, chocolate, coffee, grass, red wine, grass/mud, fruit juice, blood, tomato puree, unused motor oil, salad dressing balsamic, cooked beef fat, French squeezy mustard, make-up, and the like, or by soils caused by grease, starch based soils such as rice, pasta, protein based soils such as egg yolk, mayonnaise, lipstick, starch based soils, and the like and other remaining on the corresponding surfaces. Deposits are thus any form of unwanted residues of impureness, of dirt, food, grease etc.

The term “substrate” in the context of the present invention includes fabrics, textiles, laundry, dishes, ware, carpets, any hard surfaces (such as tiles, floors or furniture), medical and dental instruments, and the like which can be contaminated with stains and/or soils and can be treated by a washing or cleaning processes.

The term “dish” or “ware” as used herein is intended to mean any form of kitchen utensil, dinner set or tableware such as but not limited to pots, cutlery, pans, plates, cops, knives, forks, spoons, glassware such as glasses, cutting boards, porcelain etc.

The term “hard surface” refers to a solid, substantially non-flexible surface such as a countertop, tile, floor, wall, panel, window, plumbing fixture, kitchen and bathroom furniture, appliance, engine, circuit board, and dish. Hard surfaces may include for example, health care surfaces and food/plant/animal processing surfaces.

Surprisingly, it was found that certain combinations of (fragrance) boosting agents as specified herein efficiently improve the fragrance intensity and the adherence of odorous substances. Additionally, it was found that these substances are highly suitable for malodor reduction and at least boost the malodor reduction effect of antimicrobial substances. Further advantageous effects were found in view of the coverage of malodors and the prevention of their formation. An odorous substance in combination with a fragrance boosting mixture as specified herein is thus preferably used for improving the olfactory properties of odorous substances and/or for boosting the adherence of odorous substances and/or for malodor reduction.

Based on the advantageous effects on malodor and fragrance intensity, the compositions according to the present invention are suitable as, or, for use in malodor management, or for modulating fragrance notes, or for the modification of fragrance notes. The compositions according to the present invention provide excellent effects for modulating, modifying or suppressing undesired fragrance notes.

In the context of the present invention the term “malodor coverage” (or malodor masking) means that the unpleasant smell of one or more substances or a composition is entirely suppressed or reduced, but the coverage is not achieved by a beneficial intrinsic odor of an added compound. Generally, an unpleasant smell of a substance or a composition is improved by adding a compound exhibiting a malodor coverage effect, however the added compound does not improve the unpleasant smell of the substance or composition due to a beneficial intrinsic odor of the added compound. The added compound is an odor neutral molecule without a beneficial intrinsic odor. Therefore, in the context of the present invention the term “malodor coverage” does not relate to fragrance compounds or compositions which only cover an unpleasant smell due to a strong beneficial intrinsic odor.

In the context of the present invention, the term “malodor management” means that the formation of an unpleasant smell is entirely suppressed or inhibited (prevention of the formation of malodor) and/or an already existing unpleasant smell is entirely suppressed or at least reduced (“malodor reduction”). For example, the suppression or inhibition of the formation of an unpleasant smell may be achieved by the suppression or inhibition of microbial activity. Therefore, “malodor management” may be achieved by inhibiting malodor development and/or malodor reduction.

The malodor reducing/covering/preventing effect in the context of the present invention means that the offensive or to most people unpleasant olfactory perception which is usually caused by particularly odorous substances, is perceivably reduced, covered or even inhibited. Thereby, the reduction is not merely based on masking with a strong fragrance.

Surfactants/Component (a), (a1), (a2), (a3):

The detergent and/or cleaning composition according to the present invention includes at least one surfactant (a1, a2, a3, a) typically used in the field of homecare.

Surfactants are added for a number of reasons, the main purposes being their washing-active properties. They remove soils from the clothing and surfaces in the washing and cleaning process and keep it suspended in the washing solution. Some surfactants perform other functions such as foam inhibition.

The detergent and/or cleaning composition according to the present invention may comprise any kind of surfactant, namely anionic surfactants, cationic surfactants, non-ionic surfactants, amphoteric/zwitterionic surfactant, and any mixture thereof.

Suitable surfactants which can be incorporated into the detergent and/or cleaning compositions according to the present invention are:

### Anionic Surfactants:

Suitable anionic surfactants for the detergent and/or cleaning compositions according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
   and any mixture thereof.

In a preferred variant of the detergent and/or cleaning composition according to the present invention, the anionic surfactant is selected from the group consisting of:
C10 to C13 alkyl benzene sulfonates;
C12 to C15 alkyl sulfates;
C12 to C14 alkyl sulfates, ethoxylated with 1 to 3 moles ethylene oxide;
C12 to C16 alpha-olefin sulfonates;
C8 to C18 alkyl carboxylates, ethoxylated with 3 to 10 moles ethylene oxide, and preferably ethoxylated with 3 to 6 moles ethylene oxide;
   and any mixture thereof.

In a more preferred variant of the detergent and/or cleaning composition according to the present invention, the anionic surfactant is selected from the group consisting of:
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
   and any mixture thereof.

Preferably, the at least one surfactant is an anionic surfactant, and preferably one that is typically used in the field of homecare.

Alternatively, the at least one surfactant is a non-ionic surfactant, and preferably one that is typically used in the field of homecare.

In a most preferred variant, the detergent and/or cleaning composition according to the present invention comprises a combined mixture of two or even more of anionic and nonionic surfactants as specified herein.

For laundry detergents, the anionic surfactant is most preferred selected from the group consisting of dodecyl benzene sulfonate, dodecyl sulfate, dodecyl sulfate, ethoxylated with 2 moles ethylene oxide, and any mixture thereof.

For hand dishwashing detergents, the anionic surfactant is most preferred selected from the group consisting of dodecyl sulfate, dodecyl sulfate, ethoxylated with 2 moles ethylene oxide, and any mixture thereof.

For hard surface cleaning detergents, the anionic surfactant is most preferred selected from the group consisting of dodecyl sulfate, dodecyl sulfate, ethoxylated with 2 moles ethylene oxide, and any mixture thereof.

### Cationic Surfactants:

Suitable cationic surfactants for the detergent and/or cleaning compositions according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the detergent and/or cleaning composition according to the present invention, the cationic surfactant is selected from the group consisting of:
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the detergent and/or cleaning composition according to the present invention, the cationic surfactant is selected from the group consisting of:
quaternary C16 to C18 alkyl ethanolamines;
quaternary C16 to C18 alkyl ammonium compounds;
C14 to C18 alkyl ammonium methosulfates;
   and any mixture thereof.

For hard surface cleaning detergents, the cationic surfactant is most preferred selected form the group consisting of quaternary C16 to C18 alkyl ammonium compounds, and any mixture thereof.

For fabric softener, the cationic surfactant is most preferred selected form the group consisting of C14 to C18 alkyl ammonium methosulfates, and any mixture thereof.

### Non-Ionic Surfactants:

Suitable non-ionic surfactants for the detergent and/or cleaning compositions according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide, and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the detergent and/or cleaning composition according to the present invention, the non-ionic surfactant is selected from the group consisting of:
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide, and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a more preferred variant of the detergent and/or cleaning composition according to the present invention, the non-ionic surfactant is selected from the group consisting of:
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a still more preferred variant of the detergent and/or cleaning composition according to the present invention, the non-ionic surfactant is selected from the group consisting of:
C10 to C18 sophorolipids;
C10 to C18 rhamnolipids;
C8 to C14 alkyl polyglycosides;
   and any mixture thereof.

Said non-ionic surfactants are particularly beneficial for preparing “green” detergent and/or cleaning compositions.

For laundry detergents, dishwashing detergents and hard surface cleaning detergents, the non-ionic surfactant is most preferred selected from the group consisting of C10 to C18 sophorolipids, C10 to C18 rhamnolipids, C8 to C14 alkyl polyglycosides, and any mixture thereof.

In a further preferred variant, for laundry detergents the non-ionic surfactant is selected from the group consisting of C12 to C14 fatty alcohols, ethoxylated with 7 moles ethylene oxide, C13 to C15 fatty alcohols, ethoxylated with 7 moles ethylene oxide, and any mixture thereof.

In a further preferred variant, for hard surface cleaning, such as for degreaser, the non-ionic surfactant is selected from the group consisting of C9 to C11 fatty alcohols, ethoxylated with 3 to 8 moles ethylene oxide, C10 fatty alcohol, ethoxylated with 3 to 8 moles ethylene oxide, and any mixture thereof.

In a further preferred variant, for automatic dishwashing, the non-ionic surfactant is selected from the group consisting of C12 to C14 fatty alcohols, ethoxylated with 5 mol ethylene oxide and/or propoxylated with 4 mol propylene oxide.

### Amphoteric/Zwitterionic Surfactants:

Suitable amphoteric/zwitterionic surfactants for the detergent and/or cleaning compositions according to the present invention may include any conventional amphoteric/zwitterionic surfactants. Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl) amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the detergent and/or cleaning compositions according to the present invention, the amphoteric/zwitterionic surfactant is selected from the group consisting of:
C10 to C15 N-(alkyl)-N, N-dimethylamine oxide;
C10 to C15 N-(alkyl)-N, N-bis(2-hydroxyethyl) amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a more preferred variant of the detergent and/or cleaning composition according to the present invention, the amphoteric/zwitterionic surfactant is selected from the group consisting of:
C12 to C14 N-(alkyl)-N, N-dimethylamine oxides;
C12 to C14 N-(alkyl)-N, N-bis(2-hydroxyethyl) amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture of the above surfactants.

For hand dishwashing detergents, the amphoteric/zwitterionic surfactant is most preferred selected from the group consisting of C12 to C14 alkylbetaines, and any mixture thereof.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

The above specified surfactants can be used either singular or in the form of mixtures of two, three, or even more surfactants, either from the same surfactant category (anionic, cationic, non-ionic, amphoteric/zwitterionic) or as mixture of surfactants of different surfactant categories.

Odorous Substance/Component (b), (b1), (b2), (b3):

The detergent and/or cleaning composition according to the present invention further includes at least one odorous substance as component (b1), (b2), (b3), (b).

The term “odorous substance” as used herein relates to a single substance. These substances are also referred to as “fragrant substances”, “perfume substances” or “fragrance substances” as well as “fragrances”.

The term “perfume oil” however refers to mixtures of two or more of the aforementioned single odorous substances (also called “perfume mixture” or “fragrance mixture” or “fragrance compositions” etc.).

However, preferably the at least one odorous substance is a compound which is used for the primary purpose of conferring or modifying an odor. Preferably, these substances or mixtures of substances are able to impart or modify the odor of a composition or formulation in a positive or pleasant way.

The composition according to the present invention preferably includes one or more perfume oils and/or fragrances. Suitable perfume oils are mixtures of natural and synthetic fragrances. Natural fragrances are extracts from flowers, stems and leaves, fruits, fruit peels, roots, woods, herbs and grasses, needles and branches, and resins and balsams. Also suitable are animal products, such as, for example, civet and castoreum.

Natural fragrances include for example the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamom, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax).

Animal raw materials, for example civet and beaver, may also be used.

Typical (synthetic) fragrance compounds are usually products of the ester, ether, aldehyde, ketone, alcohol and hydrocarbon type.

Examples of fragrance compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate.

Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal.

Examples of suitable ketones are the ionones, beta-isomethylionone and methyl cedryl ketone.

Suitable alcohols are anethol, citronellol, eugenol, isoeugenol, geraniol, linalool, phenylethyl alcohol and terpineol.

The hydrocarbons mainly include the terpenes and balsams.

However, it is preferred to use mixtures of different fragrance compounds which, together, produce an agreeable fragrance.

Other suitable perfume oils are essential oils of relatively low volatility which are mostly used as aroma components. Examples are sage oil, chamomile oil, clove oil, melissa oil, mint oil, cinnamon leaf oil, lime-blossom oil, juniper berry oil, vetiver oil, olibanum oil, galbanum oil, ladanum oil and lavendin oil.

Fragrance substances which are advantageously suitable for combining are the following examples of known odorous/odorant substances:
extracts of natural raw materials such as essential oils, concretes, absolutes, resins, resinoids, balsams, tinctures such as for example: ambergris tincture; amyris oil; angelica seed oil; angelica root oil; anise oil; valerian oil; basil oil; tree moss absolute; bay oil; artemisia oil; benzoin resin; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute cedar leaf oil; cedarwood oil; cistus oil; citronella oil; lemon oil; copaiba balsam; copaiba balsam oil; coriander oil; costus root oil; cumin oil; cypress oil; davana oil; dill weed oil; dill seed oil; eau de brouts absolute; oak moss absolute; elemi oil; tarragon oil; eucalyptus citriodora oil; eucalyptus oil; fennel oil; pine-needle oil; galbanum oil; galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; blue camomile oil; Roman camomile oil; carrot seed oil; cascarilla oil; pine-needle oil; spearmint oil; caraway oil; labdanum oil; labdanum absolute; labdanum resin; lavandin absolute; lavandin oil; lavender absolute; lavender oil; lemongrass oil; lovage oil; distilled lime oil; pressed lime oil; linaloe oil; Litsea cubeba oil; bay leaf oil; mace oil; marjoram oil; mandarin oil; massoia bark oil; mimosa absolute; ambrette oil; musk tincture; muscatel sage oil; nutmeg oil; myrrh absolute; myrrh oil; myrtle oil; clove leaf oil; clove bud oil; neroli oil; olibanum absolute; olibanum oil; opopanax oil; orange blossom absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike lavender oil; star anise oil; styrax oil; tagetes oil; fir needle oil; tea tree oil; turpentine oil; thyme oil; Tolu balsam; tonka absolute; tuberose absolute; vanilla extract; violet leaf absolute; verbena oil; vetiver oil; juniper berry oil; cognac oil; wormwood oil; wintergreen oil; ylang ylang oil; hyssop oil; civet absolute; cinnamon leaf oil; cinnamon bark oil, and fractions thereof or constituents isolated therefrom;
individual fragrance substances from the group comprising hydrocarbons, such as for example: 3-carene; alpha-pinene; beta-pinene; alpha-terpinene; gamma-terpinene; p-cymene; bisabolene; camphene; caryophyllene; cedrene; famesene; limonene; longifolene; myrcene; ocimene; valencene; (E,Z)-1,3,5-undecatriene; styrene; diphenylmethane;
aliphatic alcohols, such as for example: hexanol; octanol; 3-octanol; 2,6-dimethylheptanol; 2-methyl-2-heptanol; 2-methyl-2-octanol; (E)-2-hexenol; (E)- and (Z)-3-hexenol; 1-octen-3-ol; mixtures of 3,4,5,6,6-pentamethyl-3,4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;
aliphatic aldehydes and the acetals thereof, such as for example: hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethylacetal; 1,1-dimethoxy-2,2,5-trimethyl-4-hexene; citronellyloxyacetaldehyde; 1-(1-methoxypropoxy)-(E/Z)-3-hexene;
aliphatic ketones and the oximes thereof, such as for example: 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;
aliphatic sulphur-containing compounds, such as for example: 3-methylthio-hexanol; 3-methylthiohexyl acetate; 3-mercaptohexanol; 3-mercaptohexyl acetate; 3-mercaptohexyl butyrate; 3-acetylthiohexyl acetate; 1-menthen-8-thiol;
aliphatic nitriles, such as for example: 2-nonenoic acid nitrile; 2-undecenoic acid nitrile; 2-tridecenoic acid nitrile; 3,12-tridecadienoic acid nitrile; 3,7-dimethyl-2,6-octadienoic acid nitrile; 3,7-dimethyl-6-octenoic acid nitrile;
esters of aliphatic carboxylic acids, such as for example: (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl-isobutyrate; hexyl crotonate; ethyl isovalerate; ethyl-2-methyl pentanoate; ethyl hexanoate; allyl hexanoate; ethyl heptanoate; allyl heptanoate; ethyl octanoate; ethyl-(E,Z)-2,4-decadienoate; methyl-2-octinate; methyl-2-noninate; allyl-2-isoamyloxyacetate; methyl-3,7-dimethyl-2,6-octadienoate; 4-methyl-2-pentyl-crotonate;
acyclic terpene alcohols, such as for example: citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates and 3-methyl-2-butenoates thereof;
acyclic terpene aldehydes and ketones, such as for example: geranial; neral; citronellal; 7-hydroxy-3,7-dimethyloctanal; 7-methoxy-3,7-dimethyloctanal; 2,6,10-trimethyl-9-undecenal; geranyl acetone; and the dimethyl and diethyl acetals of geranial, neral, 7-hydroxy-3,7-dimethyloctanal;
cyclic terpene alcohols, such as for example: menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates and 3-methyl-2-butenoates thereof;

cyclic terpene aldehydes and ketones, such as for example: menthone; isomenthone; 8-mercaptomenthan-3-one; carvone; camphor; fenchone; alpha-ionone; beta-ionone; alpha-n-methyl ionone; beta-n-methyl ionone; alpha-isomethyl ionone; beta-isomethyl ionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8 (5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedarwood oil (methylcedryl ketone);
cyclic alcohols, such as for example: 4-tert-butylcyclohexanol; 3,3,5-trimethylcyclohexanol; 3-isocamphylcyclohexanol; 2,6,9-trimethyl-Z2,Z5, E9-cyclododecatrien-1-ol; 2-isobutyl-4-methyltetrahydro-2H-pyran-4-ol;
cycloaliphatic alcohols, such as for example: alpha-3,3-trimethylcyclohexylmethanol; 1-(4-isopropylcyclohexyl) ethanol; 2-methyl-4-(2,2,3-trimethyl-3-cyclopent-1-yl) butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl) pentan-3-ol; 1-(2,2,6-trimethylcyclohexyl) hexan-3-ol;
cyclic and cycloaliphatic ethers, such as for example: cineole; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodeca-hydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;
cyclic and macrocyclic ketones, such as for example: 4-tert-butylcyclohexanone; 2,2,5-trimethyl-5-pentylcyclopentanone; 2-heptylcyclopentanone; 2-pentylcyclo-pentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4 (5H)-indanone; 8-cyclohexadecen-1-one; 9-cycloheptadecen-1-one; cyclopentadecanone; cyclohexadecanone;
cycloaliphatic aldehydes, such as for example: 2,4-dimethyl-3-cyclohexene carbaldehyde; 2-methyl-4-(2,2,6-trimethyl-cyclohexen-1-yl)-2-butenal; 4-(4-hydroxy-4-methylpentyl)-3-cyclohexene carbaldehyde; 4-(4-methyl-3-penten-1-yl)-3-cyclohexene carbaldehyde;
cycloaliphatic ketones, such as for example: 1-(3,3-dimethyl-cyclohexyl)-4-penten-1-one; 2,2-dimethyl-1-(2,4-dimethyl-3-cyclohexene-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert-butyl-(2,4-dimethyl-3-cyclohexen-1-yl) ketone;
esters of cyclic alcohols, such as for example: 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5- or 6-indenyl acetate; 4,7-methano-3a,4,5,6,7,7a-hexahydro-5- or 6-indenyl propionate; 4,7-methano-3a,4,5,6,7,7a-hexahydro-5- or 6-indenyl isobutyrate; 4,7-methanooctahydro-5- or 6-indenyl acetate;
esters of cycloaliphatic alcohols, such as for example: 1-cyclohexylethyl crotonate; esters of cycloaliphatic carboxylic acids such as for example allyl-3-cyclohexyl propionate; allylcyclohexyl oxyacetate; cis- and trans-methyl dihydrojasmonate; cis- and trans-methyl jasmonate; methyl-2-hexyl-3-oxocyclopentane carboxylate; ethyl-2-ethyl-6,6-dimethyl-2-cyclohexene carboxylate; ethyl-2,3,6,6-tetramethyl-2-cyclohexene carboxylate; ethyl-2-methyl-1,3-dioxolane 2-acetate;
araliphatic alcohols, such as for example: benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl) propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl) ethanol;
esters of araliphatic alcohols and aliphatic carboxylic acids, such as for example: benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha, alpha-dimethylphenylethyl acetate; alpha, alpha-dimethylphenyl-ethyl butyrate; cinnamyl acetate; 2-phenoxyethyl isobutyrate; 4-methoxybenzyl acetate;
araliphatic ethers, such as for example: 2-phenyl ethyl methyl ether; 2-phenyl ethyl isoamyl ether; 2-phenyl ethyl 1-ethoxyethyl ether; phenylacetaldehyde dimethylacetal; phenylacetaldehyde diethylacetal; hydratropaldehyde dimethylacetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;
aromatic and araliphatic aldehydes, such as for example: benzaldehyde; phenylacetaldehyde; 3-phenylpropanal; hydratropaldehyde; 4-methylbenz-aldehyde; 4-methylphenylacetaldehyde; 3-(4-ethylphenyl)-2,2-dimethylpropanal; 2-methyl-3-(4-isopropylphenyl) propanal; 2-methyl-3-(4-tert-butylphenyl) propanal; 2-methyl-3-(4-isobutylphenyl) propanal; 3-(4-tert-butylphenyl) propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl) propanal; 2-methyl-3-(4-methylenedioxyphenyl) propanal;
aromatic and araliphatic ketones, such as for example: acetophenone; 4-methyl-acetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl) ethanone; 2-benzofuranylethanone; (3-methyl-2-benzofuranyl) ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;
aromatic and araliphatic carboxylic acids and the esters thereof, such as for example: benzoic acid; phenylacetic acid; methyl benzoate; ethyl benzoate; hexyl benzoate; benzyl benzoate; methylphenyl acetate; ethylphenyl acetate; geranylphenyl acetate; phenylethylphenyl acetate; methyl cinnamate; ethyl cinnamate; benzyl cinnamate; phenylethyl cinnamate; cinnamyl cinnamate; allyl phenoxy acetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenyl glycidate; ethyl-3-methyl-3-phenyl glycidate;
nitrogenous aromatic compounds, such as for example: 2,4,6-trinitro-1,3-dimethyl-5-tert-butylbenzene; 3,5-dinitro-2,6-dimethyl-4-tert-butyl aceto-phenone; cinnamonitrile; 3-methyl-5-phenyl-2-pentenoic acid nitrile; 3-methyl-5-phenylpentanoic acid nitrile; methyl anthranilate; methyl-N-methyl anthranilate; Schiff bases of methyl anthranilate with 7-hydroxy-3,7-dimethyloctanal, 2-methyl-3-(4-tert-butylphenyl) propanal or 2,4-dimethyl-3-cyclohexene carbaldehyde 6-isopropyl quinoline; 6-isobutyl quinoline; 6-sec-butyl quinoline; 2-(3-phenylpropyl)pyridine; indole; skatole; 2-methoxy-3-isopropylpyrazine; 2-isobutyl-3-methoxypyrazine;
phenols, phenyl ethers and phenyl esters, such as for example: estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl) phenol; p-cresyl phenyl acetate;
heterocyclic compounds, such as for example: 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
lactones, such as for example: 1,4-octanolide; 3-methyl-1,4-octanolide; 1,4-nonanolide; 1,4-decanolide; 8-decen-1,4-olide; 1,4-undecanolide; 1,4-dodecan-olide; 1,5-decanolide; 1,5-dodecanolide; 4-methyl-1,4-decanolide; 1,15-penta-decanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin; octahydrocoumarin;
and any mixtures of the above substances.

The above specified odorous substances can be used either singular or in the form of mixtures of two, three, or even more odorous substances, either from the same type (natural, synthetic, ether, ester etc.) or as mixture of odorous substances of different types. This means that the fragrance substances specified above can be used, either as individual substances or in mixtures with at least one, two, three or even more fragrance substances, in a large number of fragrance mixtures, selected from an extensive range of natural and synthetic substances.

For the detergent and/or cleaning composition according to the present invention, the list of odorous substances (b1, b2, b3, b) specified herein can be arbitrary combined with the list of surfactants specified herein as well as the list of (fragrance) boosting agents as specified herein.

In detergent and/or cleaning compositions, the amount of the odorous substance or mixture of odorous substances is preferably comprised in amounts of around 0.00001% to 10% by weight, preferably 0.0001% to 5% by weight and particularly preferably 0.001% to 2% by weight, relative to the total amount of the detergent and/or cleaning compositions.

Fragrance compositions which contain the at least one odorous substance may be used in liquid form, undiluted or diluted with a solvent. Solvents suitable for this purpose are for example ethanol, isopropanol, diethylene glycol monoethyl ether, glycerol, propylene glycol, 1,2-butylene glycol, dipropylene glycol, diethyl phthalate, triethyl citrate, isopropyl myristate, triacetin, vegetable oils, etc.

Moreover, fragrance compositions which contain one or more odorous substances may be adsorbed on a carrier which ensures both a fine distribution of the fragrance substances in the product and controlled release upon use. Such carriers may be porous inorganic materials such as sodium sulphate, silica gels, zeolites, gypsums, clays, clay granules, aerated concrete etc., or organic materials such as woods, cellulose-based substances, sugars, dextrins (for example maltodextrin), or plastics such as PVC, polyvinyl acetates or polyurethanes. Additionally, the one or more odorous substances may be provided in microencapsulated form, in spray-dried form or as inclusion complexes or as extrusion products.

The odorous substances may be encapsulated, for example, by coacervation methods with the assistance of capsule materials made for example from polyurethane-type substances or soft gelatin.

Spray-dried fragrance compositions may be produced for example by spray-drying an emulsion or dispersion containing the fragrance substance composition, wherein modified starches, proteins, dextrin and vegetable gums may be used as carriers. Inclusion complexes may be produced for example by introducing dispersions of the fragrance substance composition and cyclodextrins or urea derivatives into a suitable solvent, for example water.

Extrusion products may be produced by melting the fragrance substance compositions with a suitable waxy substance and extruding with subsequent solidification, optionally in a suitable solvent, for example isopropanol.

### Boosting Composition or Mixture/Fragrance Booster/Component (c):

The detergent and/or cleaning composition according to the present invention further includes at least one boosting component/mixture/composition (c). These are also referred to as fragrance boosting agent/component or fragrance booster/boosting component or mixture or composition.

Boosting agent mixtures or boosting compositions (c) within the meaning of the present invention are mixtures of (c1.1) 1,2-heptanediol, (c2.1) 2,3-heptanediol, (c3.1) a mixture of 1,2-heptanediol and 2,3-heptanediol, (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol with (c^{II}) glyceryl caprylate and/or (c^{III}) 4-hydroxyacetophenone and/or (c^{IV}) ethyl hexyl glycerin. Preferably, boosting compositions (c) within the meaning of the present invention are mixtures of (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol with (c^{II}) glyceryl caprylate and/or (c^{III}) 4-hydroxyacetophenone and/or (c^{IV}) ethyl hexyl glycerin.

Thus, the first boosting component of the boosting component or mixture (c) in the composition [alkanediol component] according to the present invention is preferably either 1,2-heptanediol (c1.1) or 2,3-heptanediol (c2.1), or a mixture comprising both heptanediols, i.e. 1,2-heptanediol plus 2,3-heptanediol (c3.1).

Accordingly, the boosting component (c) is based on a mixture of at least one (first) alkanediol boosting component ((first) boosting agent/component) as specified herein and at least one further or second boosting component (further or second boosting agent/component) selected from the group consisting of glyceryl caprylate, 4-hydroxyacetophenone, ethyl hexyl glycerin or any mixture of these further boosting agents.

Surprisingly, mixtures of at least one alkanediol with at least one of glyceryl caprylate, 4-hydroxyacetophenone, and/or ethyl hexyl glycerin show excellent fragrance boosting properties, i.e. the intensity and the adherence of the fragrances contained in the detergent and/or cleaning compositions is improved even when using small amounts of the fragrance component without requiring the addition of fixatives and the like. Simultaneously, these boosters provide for an improved reduction of malodour and efficiently prevent the formation of malodor and result in an improved cleaning performance. Based on these boosting effects, the overall amount of ingredients such as fragrances and other additives can be considerable reduced, thereby advantageously reducing the allergic potential of the final product formulation and its environmental impact. This improvement in the properties is based on a synergistical interaction between the at least one alkanediol (boosting agent) and the at least one further boosting agent. Additionally, this improvement in the properties is based on a synergistical interaction between the boosting component (c) and the components (a) and (b).

More specifically, mixtures of these boosting agents as specified above were found to efficiently boost or improve the cleaning efficiency and simultaneously enhance the olfactory properties of odorous substances in a synergistical manner. Additionally, these substances were found to efficiently improve the adherence of odorous substances on substrates such as laundry, fabrics, textiles, dishes, ware, surfaces, and the like, treated with the corresponding detergent and/or cleaning composition while simultaneously providing for an improved malodor reduction and/or malodor coverage and/or malodor prevention.

Furthermore, it was surprisingly found, that the substances of component (c) boost the performance of common antimicrobial substances.

### Alkanediols (c1.1), (c2.1), (c3.1), (c^{I})

The first component of the boosting component or mixture (c) [i.e. the alkanediol component] in the detergent and/or cleaning composition according to the present invention is preferably either 1,2-heptanediol (c1.1) or 2,3-heptanediol (c2.1), or a mixture comprising both heptanediols, i.e. 1,2-heptanediol plus 2,3-heptanediol (c3.1).

1,2-Heptanediol belongs to the category of alkanediols and is a straight chain alkanediol with the general formula:

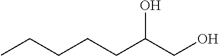

It has a carbon chain with 7 carbon atoms and the two functional OH-groups of the alkanediol are in alpha, beta-position and chemically bonded to the C1 and C2 carbon atoms in the alkanediol chain.

2,3-Heptanediol likewise belongs to the category of alkanediols and is a straight chain alkanediol with the general formula:

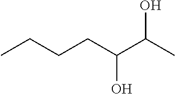

It has a carbon chain with 7 carbon atoms and the two functional OH-groups of the alkanediol are in beta, gamma-position and chemically bonded to the C2 and C3 carbon atoms in the alkanediol chain.

The first component of the fragrance boosting component (c) in the detergent and/or cleaning composition according to the present invention [i.e. the alkanediol component] is selected from the group consisting of:
(c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol.

In an even more preferred variant, the at least one linear alkanediol, the at least one first linear alkanediol and/or the one or more second linear alkanediol have a carbon chain length of 7 to 14 carbon atoms, and further preferred a carbon chain length from 7 to 12 carbon atoms, more preferred a carbon chain length from 7 to 10 carbon atoms, and most preferred a carbon chain length from 7 to 9 carbon atoms. Most preferred the at least one linear alkanediol has a carbon chain of 7 or 8 carbon atoms. In combination with a further (second) boosting component selected from the group consisting of glyceryl caprylate, 4-hydroxyacetophenone, ethyl hexyl glycerin or any mixture thereof, these alkanediols were found to exhibit the best fragrance boosting properties, i.e. enhancing the olfactory properties of odorous substances and their adherence to substrates while simultaneously providing for an improvement in malodor reduction/coverage/prevention compared to shorter chained alkanediols. For these alkanediols particularly pronounced boosting effects were observed.

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, like 1,2-pentanediol, 1,2-hexanediol and 1,2-heptanediol, are soluble both in water and oils. In contrast, 1,2-octanediol is a solid and tends to precipitate or recrystallize in oily solutions as well as in water at ≥0.5%. On the other hand, 1,2-decanediol is a solid and soluble only in oils. Apart from moisturizing, some 1,2-alkanediols are used as viscosity modifiers.

The boosting agent (c^{I}) of the detergent and/or cleaning composition according to the present invention is in a first alternative at least one linear alkanediol having a carbon chain of 5 to 14 carbon atoms, and preferably a carbon chain of 7 to 14 carbon atoms, and even more preferred a carbon chain of 7 to 12 carbon atoms and more preferred of 7 to 10 carbon atoms. Most preferred the at least one linear alkanediol has a carbon chain of 7 to 9 carbon atoms and further preferred a carbon chain of 7 or 8 carbon atoms. For these alkanediols particularly pronounced boosting effects were observed.

Moreover, in a second alternative, the boosting component (c^{I}) may include at least one first linear alkanediol in combination with one or more second linear alkanediol, preferably wherein the at least one first linear alkanediol has a carbon chain of 5 to 14 carbon atoms (and preferably a carbon chain of 7 to 14 carbon atoms, further preferred a carbon chain of 7 to 12 carbon atoms, and even more preferred a carbon chain of 7 to 10 carbon atoms, and most preferred 7 to 9 carbon atoms and further preferred a carbon chain of 7 or 8 carbon atoms) and the at least one second linear alkanediol has a carbon chain of 5 to 14 carbon atoms (and preferably a carbon chain of 7 to 14 carbon atoms, further preferred a carbon chain of 7 to 12 carbon atoms, and even more preferred a carbon chain of 7 to 10 carbon atoms, and most preferred 7 to 9 carbon atoms and further preferred a carbon chain of 7 or 8 carbon atoms). Therefore, the invention also entails a mixture comprising a first and a second alkanediol as described herein.

Since the first linear alkanediol of the invention can be selected from the same lists and types of compounds as the linear alkanediol according to the first alternative, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 14 carbon atoms or can comprise one first linear alkanediol having a carbon chain of 5 to 14 carbon atoms or can comprise more than one linear alkanediol or can comprise more than one first linear alkanediol having a carbon chain of 5 to 14 carbon atoms, i.e. two, three, four or more different linear alkanediols or first linear alkanediols having a carbon chain of 5 to 14 carbon atoms.

The at least one linear alkanediol or the at least one first linear alkanediol according to the present invention consists of a chain of 5 to 14 carbon atoms (and preferably a carbon chain of 7 to 14 carbon atoms, further preferred a carbon chain of 7 to 12 carbon atoms, and even more preferred a carbon chain of 7 to 10 carbon atoms, and most preferred 7 to 9 carbon atoms and further preferred a carbon chain of 7 or 8 carbon atoms) joined to each other by single covalent bonds with two OH-functional groups attached to two different carbon atoms in the chain.

The at least one linear alkanediol or the at least one first linear alkanediol having a carbon chain of 5 to 14 carbon atoms in the detergent and/or cleaning composition according to the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one linear alkanediol or the at least one first linear alkanediol has a carbon chain of 7 to 14 carbon atoms and is selected from the group consisting of heptanediol, octanediol, nonanediol, decanediol, undecanediol, dodecanediol tridecanediol, and tetradecanediol.

In a more preferred variant, the at least one linear alkanediol or the at least one first linear alkanediol has a carbon chain of 7 to 12 carbon atoms and is selected from the group consisting of heptanediol, octanediol, nonanediol, decanediol, undecanediol, and dodecanediol.

In a further preferred variant, the at least one linear alkanediol or the at least one first linear alkanediol has a carbon chain of 7 to 10 carbon atoms and is selected from the group consisting of heptanediol, octanediol, nonanediol, and decanediol. In a most preferred variant, the at least one linear alkanediol or the at least one first linear alkanediol has a carbon chain of 7 to 9 carbon atoms and is selected from the group consisting of heptanediol, octanediol, and nonanediol.

In a most preferred variant, the at least one linear or the at least one first linear alkanediol has a carbon chain of 7 or 8 carbon atoms in the detergent and cleaning composition according to the present invention and is selected from the group consisting of heptanediol, octanediol, and nonanediol. Thus, in a more preferred variant, the at least one linear alkanediol or the at least one first linear alkanediol is selected from the group consisting of alkanediols having a number of carbon atoms of 7 and 8, i.e. heptanediol, octanediol, and any mixture thereof.

In a still more preferred variant, the at least one linear alkanediol or the at least one first linear alkanediol is selected from the group consisting of alkanediols having a higher number of carbon atoms of 9 to 14, i.e. nonanediol, decanediol, undecanediol, dodecanediol, tridecanediol, tetradecanediol and any mixture thereof, or is selected from the group consisting of alkanediols having a number of carbon atoms of 9 to 13, i.e. nonanediol, decanediol, undecanediol, dodecanediol, tridecanediol, and any mixture thereof, or is selected from the group consisting of alkanediols having a number of carbon atoms of 9 to 12, i.e. nonanediol, decanediol, undecanediol, dodecanediol, and any mixture thereof, or is selected from the group consisting of alkanediols having a number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either nonanediol, decanediol, undecanediol, or dodecanediol, or any mixture thereof.

In a still more preferred variant, the at least one linear alkanediol or the at least one first linear alkanediol is selected from the group consisting of heptanediol, octanediol and nonanediol.

In a most preferred variant, the at least one linear alkanediol or the at least first linear alkanediol is heptanediol.

In a second alternative, the detergent and/or cleaning composition according to the present invention comprises as a first boosting agent a mixture comprising at least one first linear alkanediol having a carbon chain of 5 to 14 carbon atoms (and preferably a carbon chain of 7 to 14 carbon atoms, further preferred a carbon chain of 7 to 12 carbon atoms, and even more preferred a carbon chain of 7 to 10 carbon atoms, and most preferred 7 to 9 carbon atoms and further preferred a carbon chain of 7 or 8 carbon atoms) and one or more second linear alkanediol having a carbon chain of 5 to 14 carbon atoms (and preferably a carbon chain of 7 to 14 carbon atoms, further preferred a carbon chain of 7 to 12 carbon atoms, and even more preferred a carbon chain of 7 to 10 carbon atoms, and most preferred 7 to 9 carbon atoms and further preferred a carbon chain of 7 or 8 carbon atoms) which is/are different from the first linear alkanediol.

This means that the (first) fragrance boosting agent/component is an alkanediol mixture comprising at least one first linear alkanediol having a carbon chain of 5 to 14 carbon atoms and one or more, i.e. two, three, four or more second linear alkanediols having a carbon chain of 5 to 14 carbon atoms. In this alternative, the first linear alkanediol can be any of the alkanediols as described herein for the linear alkanediol in general and in particular for the first alternative.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The second linear alkanediol preferably consists of a chain of 5 to 14 carbon atoms joined to each other by single covalent bonds with two OH-functional groups attached to two different carbon atoms in the chain.

The at least one second linear alkanediol having a carbon chain of 5 to 14 carbon atoms in the detergent and/or cleaning composition according to the present invention is selected from the group consisting of pentanediol, hexanediol, heptanediol, octanediol, nonanediol, decanediol, undecanediol, dodecanediol, tridecanediol and tetradecanediol.

In a preferred variant, the at least one second linear alkanediol has a carbon chain of 7 to 14 carbon atoms and is selected from the group consisting of heptanediol, octanediol, nonanediol, decanediol, undecanediol, dodecanediol, tridecanediol and tetradecanediol.

In a further preferred variant, the at least one second linear alkanediol has a carbon chain of 7 to 12 carbon atoms and is selected from the group consisting of heptanediol, octanediol, nonanediol, decanediol, undecanediol, and dodecanediol.

In a more preferred variant, the at least one second linear alkanediol has a carbon chain of 7 to 10 carbon atoms and is selected from the group consisting of heptanediol, octanediol, nonanediol, and decanediol. In a most preferred variant, the at least one second linear alkanediol has a carbon chain of 7 to 9 carbon atoms and is selected from the group consisting of heptanediol, octanediol, and nonanediol. In a most preferred variant, the at least one second linear alkanediol has a carbon chain of 7 or 8 carbon atoms in the detergent and cleaning composition according to the first aspect of the present invention and is selected from the group consisting of heptanediol and octanediol.

In a more preferred variant, the at least one second linear alkanediol is selected from the group consisting of heptanediol, octanediol and nonanediol.

The phrase “different from each other means” that the first linear alkanediols and the second linear alkanediols in the mixture are either different with regard to the length of their carbon chain, i.e. number of the carbon atoms, or with regard to their constitutional isomerism.

Likewise, the number of the carbon atoms of the first linear alkanediols and the second linear alkanediols in the mixture can also be same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative.

In a preferred variant, the detergent and/or cleaning composition according to the present invention comprises a mixture comprising at least one first linear alkanediol having a carbon chain of 5 to 14 carbon atoms and one or more second linear alkanediol having a carbon chain of 5 to 14 carbon atoms wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms. However, beyond that, the first linear alkanediol and the second linear alkanediol can be different with regard to their constitutional isomerism or with regard to their stereoisomerism.

In a preferred variant the present invention relates to a detergent and/or cleaning composition, wherein the at least one linear alkanediol or the at least one first linear alkanediol is selected from the group consisting of pentanediol, hexanediol, heptanediol, octanediol, nonanediol, decanediol, undecanediol, dodecanediol, tridecanediol, and tetradecanediol; and/or the one or more second linear alkanediol is selected from the group consisting of pentanediol, hexanediol, heptanediol, octanediol, nonanediol, decanediol, undecanediol, dodecanediol, tridecanediol and tetradecanediol.

Particular preferred is a (fragrance) boosting agent mixture, wherein the at least one first linear alkanediol is selected from an alkanediol having a lower number of carbon atoms from 5 to 8 and wherein the one or more second alkanediol is selected from an alkanediol having a higher number of carbon atoms from 9 to 14.

Most preferred is a (fragrance) boosting agent mixture, wherein the at least one first linear alkanediol is selected from the group consisting of pentanediol, hexanediol, heptanediol, octanediol, and any mixture thereof, and the one or more second alkanediol is selected from the group consisting of nonanediol, decanediol, undecanediol, dodecanediol, tridecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only in the position of a functional group on a parent structure, which in this case, in particular, is the position of the two alcohol functions.

Depending on the number of the carbon atoms of the carbon chain of the alkanediol, there are various position isomers of the alkanediol: (x,x+1)-constitutional isomers; (x,x+2)-constitutional isomers; (x,x+3)-constitutional isomers; etc. and alpha, omega-constitutional isomers when the alcohol functions are at the terminal ends of the carbon chain, wherein x stands for the number of the carbon atom in the alkanediol chain, to which the OH-groups of the alkanediol are chemically bonded. For example: if x is 1, the two OH-groups of the alkanediol are chemically bonded to the C1 and C2 carbon atoms in the alkanediol chain; if x is 2, the two OH-groups of the alkanediol are chemically bonded to the C2 and C3 carbon atoms in the alkanediol chain, etc.

In the (x,x+1)-constitutional isomers, the two OH functional groups are vicinal attached to two different adjacent carbon atoms in the chain. In the (x,x+2)-constitutional isomers, the two OH functional groups are attached to two different carbon atoms in the chain where the two carbon atoms are separated by one carbon atom. In the (x,x+3)-constitutional isomers, the two OH functional groups are attached to two different carbon atoms in the chain where the two carbon atoms are separated by two carbon atoms. In the alpha, omega-constitutional isomers, the two functional groups are attached to the first carbon atom and to the terminal carbon atom.

In a preferred variant of the detergent and/or cleaning composition according to the present invention, the linear alkanediol having a carbon chain of 5 to 14 carbon atoms, is preferably a vicinal (x,x+1)-diol, selected from the group consisting of a 1,2-diol, 2,3-diol, 3,4-diol, 4,5-diol, further (x,x+1)-diols, and mixtures thereof, preferably an alpha, beta-1,2-constitutional isomer.

In a preferred variant of the detergent and/or cleaning composition according to the present invention, the at least one first linear alkanediol and/or the one or more second linear alkanediol having a carbon chain of 5 to 14 carbon atoms is a vicinal (x,x+1)-diol, selected from the group consisting of a 1,2-diol, 2,3-diol, 3,4-diol, 4,5-diol, further (x,x+1)-diols, and mixtures thereof, preferably an alpha, beta-1,2-constitutional isomer, and preferably the first linear alkanediol and/or the second linear alkanediol having a carbon chain of 5 to 14 carbon atoms is selected from 1,2-diols and/or 2,3-diols.

Thus, according to a preferred variant of the detergent and/or cleaning composition according to the present invention, the at least one linear alkanediol, the at least one first linear alkanediol and/or the one or more second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

According to the present invention, vicinal (x,x+1)-diols are most preferred, such as alpha, beta or beta, gamma or gamma, delta etc.

In a still preferred variant of the detergent and/or cleaning composition according to the present invention, the linear alkanediol and in particular the first linear alkanediol and/or the second linear alkanediol, is a 1,2-alkanediol, a 2,3-alkanediol, a 3,4-alkanediol, or mixtures thereof, more preferred a 2,3-alkanediol.

The 1,2-alkanediols of the linear alkanediol, in particular the first linear alkanediol having a carbon chain of 5 to 14 carbon atoms and/or the second linear alkanediol having a carbon chain of 5 to 14 carbon atoms, can preferably be those as represented by the following formulae:

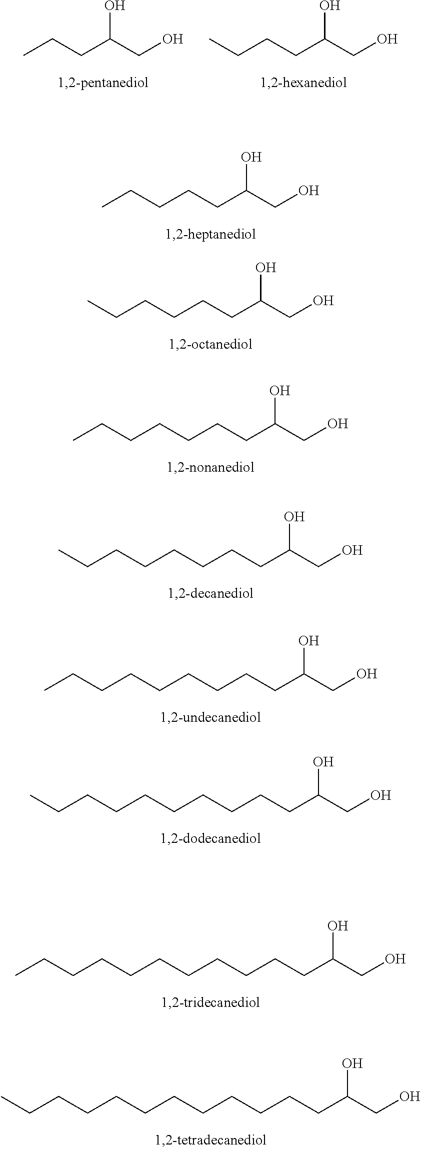

In an even more preferred variant, the 1,2-alkanediols of the linear alkanediol, in particular the first linear alkanediol and/or the second linear alkanediol have a carbon chain of 7 to 14 carbon atoms, and further preferred a carbon chain length from 7 to 12 carbon atoms, more preferred a carbon chain length of 7 to 10 carbon atoms, and most preferred a carbon chain length from 7 to 9 carbon atoms. Further preferred, the 1,2-alkanediols of the linear alkanediol, in particular the first linear alkanediol and/or the second linear alkanediol have a carbon chain of 7 or 8 carbon atoms. For these alkanediols particularly pronounced boosting effects were observed.

The 2,3-alkanediols of the linear alkanediol of the invention, in particular the first linear alkanediol having a carbon chain of 5 to 14 carbon atoms and/or the second linear alkanediol having a carbon chain of 5 to 14 carbon atoms, can preferably be those as represented by the following formulae:

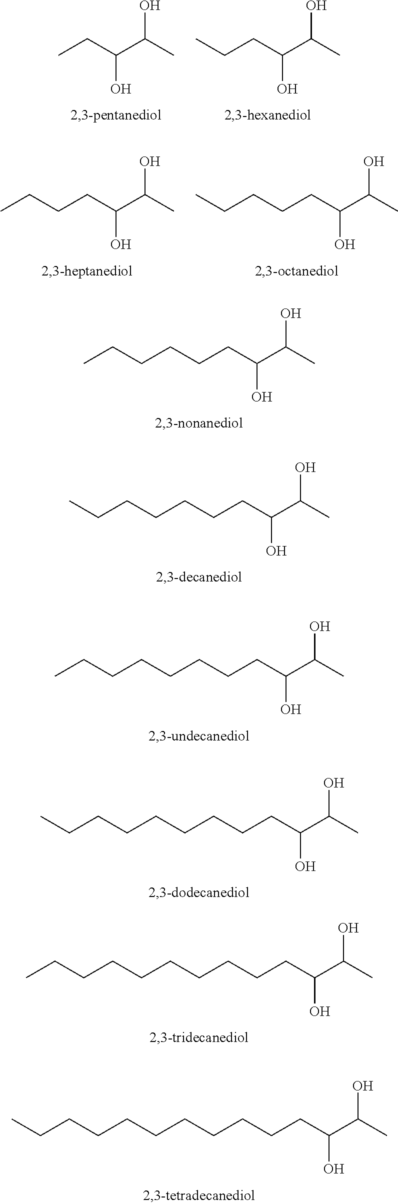

In an even more preferred variant, the 2,3-alkanediols of the linear alkanediol, in particular the first linear alkanediol and/or the second linear alkanediol have a carbon chain of 7 to 14 carbon atoms, and further preferred a carbon chain length from 7 to 12 carbon atoms, more preferred a carbon chain length of 7 to 10 carbon atoms, and most preferred a carbon chain length from 7 to 9 carbon atoms. Further preferred, the 2,3-alkanediols of the linear alkanediol, in particular the first linear alkanediol and/or the second linear alkanediol have a carbon chain of 7 or 8 carbon atoms. For these alkanediols particularly pronounced boosting effects were observed.

The 3,4-alkanediols of the linear alkanediol, preferably the first linear alkanediol having a carbon chain of 5 to 14 carbon atoms and/or the second linear alkanediol having a carbon chain of 5 to 14 carbon atoms, can preferably be those as represented by the following formulae:

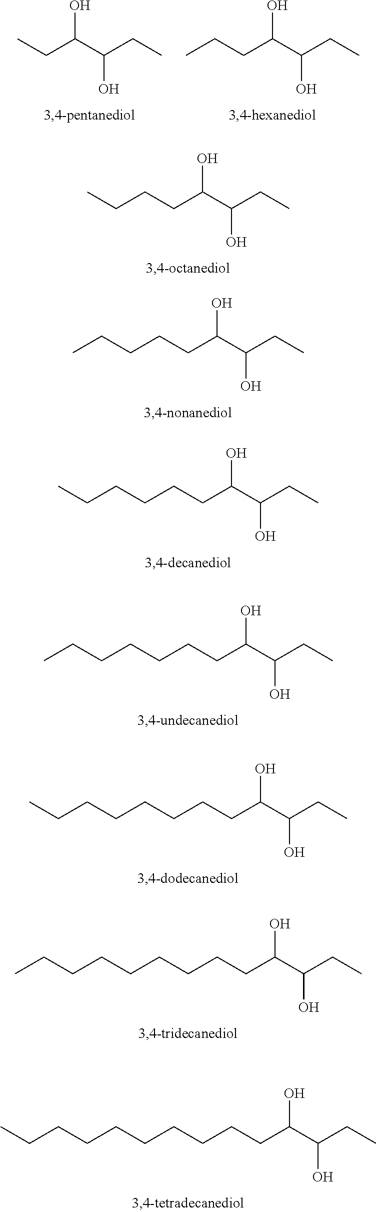

In an even more preferred variant, the 3,4-alkanediols of the linear alkanediol, in particular the first linear alkanediol and/or the second linear alkanediol have a carbon chain of 7 to 14 carbon atoms, and further preferred a carbon chain length from 7 to 12 carbon atoms, more preferred a carbon chain length of 7 to 10 carbon atoms, and most preferred a carbon chain length from 7 to 9 carbon atoms. Further preferred, the 3,4-alkanediols of the linear alkanediol, in particular the first linear alkanediol and/or the second linear alkanediol have a carbon chain of 7 or 8 carbon atoms. For these alkanediols particularly pronounced boosting effects were observed.

In a preferred variant of the detergent and/or cleaning composition according to the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
   and any mixture thereof.

Preferably, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
   and any mixture thereof.

Even more preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
   and any mixture thereof.

Further preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
   and any mixture thereof.

Most preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
   and any mixture thereof.

Most preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
   and any mixture thereof.

According to a preferred variant, in the detergent and/or cleaning composition according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a further preferred variant, in the detergent and/or cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a more preferred variant, in the detergent and/or cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

According to an even more preferred variant, in the detergent and/or cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol.

According to a most preferred variant, in the detergent and/or cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol.

According to an even more preferred variant, in the detergent and/or cleaning composition according to the present invention the linear alkanediol or the first linear alkanediol is selected from the group consisting of 1,2-heptanediol, 2,3-heptanediol, 1,2-octanediol, 2,3-octanediol.

Of the aforesaid linear alkanediols or the first linear alkanediols, the following (x,x+1)-constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90% to 99%.

Of the aforesaid liquid alkanediols 2,3-pentanediol, 2,3-hexanediol, 1,2-heptanediol, 2,3-heptanediol, 2,3-octanediol, 2,3-nonanediol or mixtures of said liquid alkanediols are particularly preferred. Of the aforesaid liquid alkanediols 1,2-heptanediol, 2,3-heptanediol, 2,3-octanediol, 2,3-nonanediol or mixtures of said liquid alkanediols are even more preferred.

In a further preferred variant of the detergent and/or cleaning composition according to the present invention, the at least one linear alkanediol or the at least one first linear alkanediol is selected from the group consisting of:
1,2-heptanediol, 2,3-heptanediol,
1,2-octanediol, 2,3-octanediol,
1,2-nonanediol, 2,3-nonanediol,
1,2-decanediol, 2,3-decanediol,
1,2-undecanediol, 2,3-undecanediol,
1,2-dodecanediol, 2,3-dodecanediol,
1,2-tridecanediol, 2,3-tridecanediol,
1,2-tetradecanediol, 2,3-tetradecanediol,
   and any mixture thereof.

In a further preferred variant of the detergent and/or cleaning composition according to the present invention, the linear alkanediol or the first linear alkanediol is selected from the group consisting of:
1,2-heptanediol, 2,3-heptanediol,
1,2-octanediol, 2,3-octanediol,
1,2-nonanediol, 2,3-nonanediol,
   and any mixture thereof.

In a more preferred variant of the detergent and/or cleaning composition according to the present invention, the linear alkanediol or the first linear alkanediol is selected from the group consisting of:
1,2-heptanediol, 2,3-heptanediol,
1,2-octanediol, 2,3-octanediol,
   and any mixture thereof.

Alternatively preferred, in the detergent and/or cleaning composition according to the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the detergent and/or cleaning composition according to the present invention, the linear alkanediol or the first linear alkanediol is an alpha, beta- or a beta, gamma-diol as either 1,2-heptanediol or 2,3-heptanediol or a mixture thereof. However, the linear alkanediol or the first linear alkanediol can also preferably be an alpha, beta- or a beta, gamma-diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 2,3-pentanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the detergent and/or cleaning composition according to the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and/or cleaning composition according to the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a number of carbon atoms of 7 to 14, i.e. 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 12, i.e. 1,2-heptanediol, 1,2-octanediol, 1,2-nonanediol, 1,2-decanediol, 1,2-undecanediol, 1,2-dodecanediol, and any mixture thereof, or is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected form the group consisting of 1,2-alkanediols having a number of carbon atoms of 7 to 9, i.e. 1,2-heptanediol, 1,2-octanediol, 1,2-nonanediol, and any mixture thereof, or is selected form the group consisting of 1,2-alkanediols having a number of carbon atoms of 7 and 8, i.e. 1,2-heptanediol, 1,2-octanediol, and any mixture thereof.

It was found that these alkanediols show particular pronounced fragrance boosting performances.

In an alternative preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol or any mixture thereof. In a still more preferred variant, the at least one linear alkanediol or the at least one first linear alkanediol is either 1,2-heptanediol or 1,2-octanediol or any mixture thereof.

In a most preferred variant, the at least one linear alkanediol or the at least first linear alkanediol is 1,2-heptanediol.

It was found that these substances show particularly pronounced fragrance boosting effects. It was found that these substances efficiently enhance the olfactory properties of odorous substances and simultaneously provide for an improved adherence of odorous substances. Furthermore, they are efficient in terms of malodor reduction/coverage/prevention. In addition, it was found that these substances remarkably improve stain and/or soil removal and show an overall improved cleaning performance. 1,2-Alkanediols having a lower number of carbon atoms are thus efficient for use as (fragrance) boosting agents in detergent and/or cleaning compositions and/or for malodor coverage and/or malodor reduction.

In a still more preferred variant, the at least one linear alkanediol or the at least one first linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-nonanediol or 1,2-decanediol or 1,2-undecanediol or 1,2-dodecanediol or any mixture thereof.

According to a preferred variant, the at least one linear alkanediol or the at least one first linear alkanediol is selected from the group consisting of 1,2-alkanediols having a higher number of carbon atoms, and more specifically more than 10 carbon atoms, i.e. 11, 12, 13, or 14 carbon atoms, i.e. 1,2-undecanediol, 1,2-dodecanediol, 1,2-tridecanediol, or 1,2-tetradecanediol.

It was found that these substances show better cleaning efficiencies and fragrance boosting properties. 1,2-Alkanediols having a higher number of carbon atoms, and more preferably more than 10 carbon atoms are thus efficient for use as boosting agents in detergent and/or cleaning compositions comprising a fragrance component within the meaning of the present invention. Both, the improved cleaning performance, and improved fragrance performance in terms of intensity and adherence result in a better performance of the detergent and/or cleaning composition in a washing or cleaning process. For example, textiles treated with the detergent and/or cleaning compositions according to the present invention show a considerably intensified and prolonged fragrance impression even when stored for a long time compared to formulations not comprising the boosting agent mixture as specified herein. In addition, these compounds provide for an improved malodor coverage and/or malodor reduction.

In a more preferred variant, the at least one linear alkanediol or the at least one first linear alkanediol is selected from the group consisting of 2,3-alkanediols having a number of carbon atoms of 7 to 14, i.e. 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 7 to 12, i.e. 2,3-heptanediol, 2,3-octanediol, 2,3-nonanediol, 2,3-decanediol, 2,3-undecanediol, 2,3-dodecanediol, and any mixture thereof, or is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected form the group consisting of 2,3-alkanediols having a number of carbon atoms of 7 to 9, i.e. 2,3-heptanediol, 2,3-octanediol, 2,3-nonanediol, and any mixture thereof, or is selected form the group consisting of 2,3-alkanediols having a number of carbon atoms of 7 and 8, i.e. 2,3-heptanediol, 2,3-octanediol, and any mixture thereof.

It was found that these alkanediols show particular pronounced fragrance boosting performances.

In an alternative preferred variant, the linear alkanediol or the first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 2,3-heptanediol, 2,3-octanediol, and any mixture thereof.

In a still more preferred variant, the at least one linear alkanediol or the at least one first linear alkanediol is either 2,3-pentanediol or 2,3-hexanediol or 2,3-heptanediol or 2,3-octanediol or any mixture thereof.

In a most preferred variant, the at least one linear alkanediol or the at least first linear alkanediol is 2,3-heptanediol.

It was found that these substances show particularly pronounced fragrance boosting effects. It was found that these substances efficiently enhance the olfactory properties of odorous substances and simultaneously provide for an improved adherence of odorous substances. Furthermore, they are efficient in terms of malodor reduction/coverage/prevention. In addition, it was found that these substances remarkably improve stain and/or soil removal and show an overall improved cleaning performance. 2,3-Alkanediols having a lower number of carbon atoms are thus efficient for use as (fragrance) boosting agents in detergent and/or cleaning compositions and/or for malodor coverage and/or malodor reduction.

In a still more preferred variant, the at least one linear alkanediol or the at least one first linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tetradecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the at least one linear alkanediol or the at least one first linear alkanediol is either 2,3-nonanediol, 2,3-decanediol, 2,3-undecanediol or 2,3-dodecanediol, or any mixture thereof.

According to a preferred variant, the at least one linear alkanediol or the at least one first linear alkanediol is selected from the group consisting of 2,3-alkanediols having a higher number of carbon atoms, and more specifically more than 10 carbon atoms, i.e. 11, 12, 13 or 14 carbon atoms, i.e. 2,3-undecanediol, 2,3-dodecanediol, 2,3-tridecanediol, or 2,3-tetradecanediol.

It was found that these substances show better cleaning efficiencies and fragrance boosting properties. 2,3-Alkanediols having a higher number of carbon atoms, and more preferably more than 10 carbon atoms are thus efficient for use as boosting agents in detergent and/or cleaning compositions comprising a fragrance component within the meaning of the present invention. Both, the improved cleaning performance, and improved fragrance performance in terms of intensity and adherence result in a better performance of the detergent and/or cleaning composition in a washing or cleaning process. For example, textiles treated with the detergent and/or cleaning compositions according to the present invention show a considerably intensified and prolonged fragrance impression even when stored for a long time compared to formulations not comprising the boosting agent mixture as specified herein. In addition, these compounds provide for an improved malodor coverage and/or malodor reduction.

In a preferred variant of the detergent and/or cleaning composition according to the present invention, the one or more second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
   and any mixture thereof.

Preferably, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
   and any mixture thereof.

More preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
   and any mixture thereof.

Even more preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
   and any mixture thereof.

Most preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
   and any mixture thereof.

Most preferred, the second linear alkanediol is selected from the group consisting of:
1,2-heptanediol, 2,3-heptanediol, 3,4-heptanediol,
1,2-octanediol, 2,3-octanediol, 3,4-octanediol,
   and any mixture thereof.

According to a preferred variant, in the detergent and/or cleaning composition according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a further preferred variant, in the detergent and/or cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a more preferred variant, in the detergent and/or cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

According to a further preferred variant, in the detergent and/or cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

According to a most preferred variant, in the detergent and/or cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, and any mixture thereof. According to a most preferred variant, in the detergent and/or cleaning composition according to the present invention the second linear alkanediol is selected from the group consisting of 1,2-heptanediol, 2,3-heptanediol, 1,2-octanediol, 2,3-octanediol, and any mixture thereof.

Of the aforesaid second linear alkanediols, the following (x,x+1)-constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90% to 99%.

Of the aforesaid liquid alkanediols 2,3-pentanediol, 2,3-hexanediol, 1,2-heptanediol, 2,3-heptanediol, 2,3-octanediol, 2,3-nonanediol or mixtures of said liquid alkanediols are particularly preferred. Of the aforesaid liquid alkanediols 1,2-heptanediol, 2,3-heptanediol, 2,3-octanediol, 2,3-nonanediol or mixtures of said liquid alkanediols are even more preferred.

In a further preferred variant of the detergent and/or cleaning composition according to the present invention, the second linear alkanediol is selected from the group consisting of:
1,2-heptanediol, 2,3-heptanediol,
1,2-octanediol, 2,3-octanediol,
1,2-nonanediol, 2,3-nonanediol,
   and any mixture thereof.

In a more preferred variant of the detergent and/or cleaning composition according to the present invention, the second linear alkanediol is selected from the group consisting of:
1,2-heptanediol, 2,3-heptanediol,
1,2-octanediol, 2,3-octanediol,
   and any mixture thereof.

Alternatively preferred, in the detergent and/or cleaning composition according to the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the detergent and/or cleaning composition according to the present invention, the second linear alkanediol is an alpha, beta- or a beta, gamma-diol as either 1,2-pentanediol or 2,3-pentanediol or a mixture thereof. However, the second linear alkanediol can also preferably be an alpha, beta- or a beta,gamma-diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 2,3-pentanediol or 2,3-hexanediol or 1,2-heptanediol or 2,3-heptanediol, or 2,3-octanediol or 2,3-nonanediol.

Likewise, in a further preferred variant of the detergent and/or cleaning composition according to the present invention, the second linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and/or cleaning composition according to the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one second linear alkanediol is selected from the group consisting of 1,2-alkanediols having a number of carbon atoms of 7 to 14, i.e. 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 12, i.e. 1,2-heptanediol, 1,2-octanediol, 1,2-nonanediol, 1,2-decanediol, 1,2-undecanediol, 1,2-dodecanediol, and any mixture thereof, or is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected form the group consisting of 1,2-alkanediols having a number of carbon atoms of 7 to 9, i.e. 1,2-heptanediol, 1,2-octanediol, 1,2-nonanediol, and any mixture thereof, or is selected form the group consisting of 1,2-alkanediols having a number of carbon atoms of 7 and 8, i.e. 1,2-heptanediol, 1,2-octanediol, and any mixture thereof.

It was found that these alkanediols show particular pronounced fragrance boosting performances.

In an alternative preferred variant, the second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol or any mixture thereof. In a still more preferred variant, the second linear alkanediol is either 1,2-heptanediol or 1,2-octanediol or any mixture thereof.

In a most preferred variant, the second linear alkanediol is 1,2-heptanediol.

It was found that these substances show particularly pronounced fragrance boosting effects. It was found that these substances efficiently enhance the olfactory properties of odorous substances and simultaneously provide for an improved adherence of odorous substances. Furthermore, they are efficient in terms of malodor reduction/coverage/prevention. In addition, it was found that these substances remarkably improve stain and/or soil removal and show an overall improved cleaning performance. 1,2-Alkanediols having a lower number of carbon atoms are thus efficient for use as (fragrance) boosting agents in detergent and/or cleaning compositions and/or for malodor coverage and/or malodor reduction.

In a still more preferred variant, the second linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-nonanediol or 1,2-decanediol or 1,2-undecanediol or 1,2-dodecanediol or any mixture thereof.

According to a preferred variant, the second linear alkanediol is selected from the group consisting of 1,2-alkanediols having a higher number of carbon atoms, and more specifically more than 10 carbon atoms, i.e. 11, 12, 13 or 14 carbon atoms, i.e. 1,2-undecanediol, 1,2-dodecanediol, 1,2-tridecanediol, or 1,2-tetradecanediol.

It was found that these substances show better cleaning efficiencies and fragrance boosting properties. 1,2-Alkanediols having a higher number of carbon atoms, and more preferably more than 10 carbon atoms are thus efficient for use as boosting agents in detergent and/or cleaning compositions comprising a fragrance component within the meaning of the present invention. Both, the improved cleaning performance and improved fragrance performance in terms of intensity and adherence result in a better performance of the detergent and/or cleaning composition in a washing or cleaning process. For example, textiles treated with the detergent and/or cleaning compositions according to the present invention show a considerably intensified and prolonged fragrance impression even when stored for a long time compared to formulations not comprising the boosting agent mixture as specified herein. In addition, these compounds provide for an improved malodor coverage and/or malodor reduction.

In a more preferred variant, the at least one second linear alkanediol is selected from the group consisting of 2,3-alkanediols having a number of carbon atoms of 7 to 14, i.e. 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 7 to 12, i.e. 2,3-heptanediol, 2,3-octanediol, 2,3-nonanediol, 2,3-decanediol, 2,3-undecanediol, 2,3-dodecanediol, and any mixture thereof, or is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected form the group consisting of 2,3-alkanediols having a number of carbon atoms of 7 to 9, i.e. 2,3-heptanediol, 2,3-octanediol, 2,3-nonanediol, and any mixture thereof, or is selected form the group consisting of 2,3-alkanediols having a number of carbon atoms of 7 and 8, i.e. 2,3-heptanediol, 2,3-octanediol, and any mixture thereof.

It was found that these alkanediols show particular pronounced fragrance boosting performances.

In an alternative preferred variant, the second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol or any mixture thereof. In a still more preferred variant, the second linear alkanediol is either 2,3-heptanediol or 2,3-octanediol or any mixture thereof.

In a most preferred variant, the second linear alkanediol is 2,3-heptanediol.

It was found that these substances show particularly pronounced fragrance boosting effects. It was found that these substances efficiently enhance the olfactory properties of odorous substances and simultaneously provide for an improved adherence of odorous substances. Furthermore, they are efficient in terms of malodor reduction/coverage/prevention. In addition, it was found that these substances remarkably improve stain and/or soil removal and show an overall improved cleaning performance. 2,3-Alkanediols having a lower number of carbon atoms are thus efficient for use as (fragrance) boosting agents in detergent and/or cleaning compositions and/or for malodor coverage and/or malodor reduction.

In a still more preferred variant, the second linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tridecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-nonanediol or 2,3-decanediol or 2,3-undecanediol or 2,3-dodecanediol or any mixture thereof.

According to a preferred variant, the second linear alkanediol is selected from the group consisting of 2,3-alkanediols having a higher number of carbon atoms, and more specifically more than 10 carbon atoms, i.e. 11, 12, 13 or 14 carbon atoms, i.e. 2,3-undecanediol, 2,3-dodecanediol, 2,3-tridecanediol, or 2,3-tetradecanediol.

It was found that these substances show better cleaning efficiencies and fragrance boosting properties. 2,3-Alkanediols having a higher number of carbon atoms, and more preferably more than 10 carbon atoms are thus efficient for use as boosting agents in detergent and/or cleaning compositions comprising a fragrance component within the meaning of the present invention. Both, the improved cleaning performance and improved fragrance performance in terms of intensity and adherence result in a better performance of the detergent and/or cleaning composition in a washing or cleaning process. For example, textiles treated with the detergent and/or cleaning compositions according to the present invention show a considerably intensified and prolonged fragrance impression even when stored for a long time compared to formulations not comprising the boosting agent mixture as specified herein. In addition, these compounds provide for an improved malodor coverage and/or malodor reduction.

In a particular preferred variant, in the detergent and/or cleaning composition according to the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a particularly preferred variant, the detergent and/or cleaning composition according to the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol; or
a mixture comprising 1,2-dodecanediol and 2,3-dodecanediol; or
a mixture comprising 1,2-tridecanediol and 2,3-tridecanediol; or
a mixture comprising 1,2-tetradecanediol and 2,3-tetradecanediol.

In said homo alkanediol mixtures the first linear alkanediol and the second linear alkanediol have the same number of carbon atoms.

Particularly favorable is a mixture including 1,2-pentanediol in combination with 2,3-pentanediol, or a mixture including 1,2-heptanediol in combination with 2,3-heptanediol, or a mixture including 1,2-octanediol in combination with 2,3-octanediol and/or 3,4-octanediol. Further preferred is a mixture including 1,2-heptanediol in combination with 2,3-heptanediol, or a mixture including 1,2-octanediol in combination with 2,3-octanediol and/or 3,4-octanediol.

Due to their outstanding boosting effect in view of the fragrance performance and improved cleaning efficiency a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred. In addition, the malodor coverage and/or reduction properties are enhanced in a synergistical manner.

The above specified homo alkanediol mixtures according to the present invention, comprising a 1,2-alkanediol and a 2,3-alkanediol are characterized by a synergistically intensified action, i.e. the alkanediol mixtures show increased cleaning performances along with remarkable fragrance boosting properties in terms of intensity and adherence in a synergistic way compared to their respective single 1,2-alkanediol or 2,3-alkanediol substances. In addition, the malodor coverage and/or reduction properties are enhanced in a synergistical manner.

Said synergistic effect or action in improving the cleaning efficiency and simultaneously boosting the fragrance performance is also found for the homo mixture including 1,2-pentanediol and 2,3-pentanediol. In addition, the malodor coverage and/or reduction properties are enhanced in a synergistical manner.

Said synergistic effect of boosting the intensity and adhesion of an odorous substance is also observed for the homo mixture including 1,2-hexanediol and 2,3-hexanediol. In addition, the malodor coverage and/or reduction properties are enhanced in a synergistical manner.

The homo mixture including 1,2-heptanediol and 2,3-heptanediol is particularly beneficial since it has a particularly pronounced synergistic boosting effect on the fragrance performance and its adhesion properties in a detergent and/or cleaning composition. In addition, the malodor coverage and/or reduction properties are enhanced in a synergistical manner.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically boosting an odorous substance when used in a detergent and/or cleaning composition. In addition, the malodor coverage and/or reduction properties are enhanced in a synergistical manner.

Also, the alkanediol mixture comprising 1,2-decanediol and 2,3-decanediol or the alkanediol mixture comprising 1,2-undecanediol and 2,3-undecanediol synergistically enhance the fragrance performance of an odorous substance in a detergent and/or cleaning composition. In addition, the malodor coverage and/or reduction properties are enhanced in a synergistical manner.

A fragrance boosting effect is also observed for an alkanediol mixture including 1,2-dodecanediol and 2,3-dodecanediol or an alkanediol mixture including 1,2-tridecanediol and 2,3-tridecanediol. In addition, the malodor coverage and/or reduction properties are enhanced in a synergistical manner.

The afore-mentioned synergistically improving effect towards the performance of a fragrance component in a cleaning performance is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol. In addition, the malodor coverage and/or reduction properties are enhanced in a synergistical manner.

The afore specified homo alkanediol mixtures including a 1,2-alkanediol and the corresponding 2,3-alkanediol display a remarkably synergistic boosting effect and are clearly superior to the individually corresponding 1,2-alkanediols or 2,3-alkanediols and having the same concentration.

In a particularly preferred variant, the detergent and/or cleaning composition according to the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
1,2-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
1,2-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
1,2-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
1,2-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
1,2-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
1,2-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
1,2-pentanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-hexanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-heptanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-octanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-nonanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-decanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-undecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-tridecanediol in combination with one of 2,3-pentanediol, 2,3-hexanediol, 2,3-heptanediol, 2,3-octanediol, 2,3-nonanediol, 2,3-dodecanediol, 2,3-undecanediol, 2,3-dodecanediol, 2,3-tridecanediol, 2,3-tetradecanediol; or
1,2-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
2,3-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
2,3-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
2,3-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
2,3-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
2,3-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
2,3-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
2,3-pentanediol in combination with one of 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-hexanediol in combination with one of 2,3-pentanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-heptanediol in combination with one of 2,3-pentanediol, 2,3-hexanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-octanediol in combination with one of 2,3-pentanediol, 2,3-hexanediol, 2,3-heptanediol, 2,3-nonanediol, 2,3-decanediol, 2,3-undecanediol, 2,3-dodecanediol, 2,3-tridecanediol, or 2,3-tetradecanediol; or
2,3-nonanediol in combination with one of 2,3-pentanediol, 2,3-hexanediol, 2,3-heptanediol, 2,3-octanediol, 2,3-decanediol, 2,3-undecanediol, 2,3-dodecanediol, 2,3-tridecanediol, or 2,3-tetradecanediol; or
2,3-decanediol in combination with one of 2,3-pentanediol, 2,3-hexanediol, 2,3-heptanediol, 2,3-octanediol, 2,3-nonanediol, 2,3-undecanediol, 2,3-dodecanediol, 2,3-tridecanediol, or 2,3-tetradecanediol; or
2,3-undecanediol in combination with one of 2,3-pentanediol, 2,3-hexanediol, 2,3-heptanediol, 2,3-octanediol, 2,3-nonanediol, 2,3-decanediol, 2,3-dodecanediol, 2,3-tridecanediol, or 2,3-tetradecanediol; or
2,3-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-tridecanediol, or 2,3-tetradecanediol; or
2,3-tridecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, or 2,3-tetradecanediol; or
2,3-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol or 2,3-tridecanediol.

In a particular preferred variant, the detergent and/or cleaning composition according to the present invention which comprises a mixture or a combination comprising at least one first linear alkanediol and one or more second linear alkanediol thus may include any of the following mixtures/combinations:
a mixture comprising 1,2-hexanediol and 1,2-octanediol; or
a mixture comprising 1,2-hexanediol and 2,3-octanediol; or
a mixture comprising 1,2-octanediol and 2,3-hexanediol; or
a mixture comprising 1,2-octanediol and 2,3-heptanediol; or
a mixture comprising 1,2-pentanediol and 2,3-hexanediol; or
a mixture comprising 1,2-pentanediol and 2,3-heptanediol; or
a mixture comprising 1,2-pentanediol and 2,3-octanediol; or
a mixture comprising 1,2-pentanediol and 1,2-nonanediol; or
a mixture comprising 1,2-pentanediol and 2,3-nonanediol; or
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 2,3-octanediol; or
a mixture comprising 1,2-heptanediol and 1,2-nonanediol; or
a mixture comprising 1,2-heptanediol and 2,3-nonanediol; or
a mixture comprising 1,2-heptanediol and 1,2-decanediol; or
a mixture comprising 1,2-heptanediol and 1,2-undecanediol; or
a mixture comprising 1,2-heptanediol and 1,2-dodecanediol; or
a mixture comprising 1,2-heptanediol and 1,2-tridecanediol.

In said hetero alkanediol mixtures the first linear alkanediol and the second linear alkanediol have a different number of carbon atoms.

The afore specified alkanediol mixtures according to the present invention, comprising at least one first linear alkanediol and one or more second linear alkanediol, are characterized by synergistically intensified action, i.e. the alkanediol mixtures enhance the fragrance performance of an odorous substance in a detergent and/or cleaning composition in a synergistic way compared to the corresponding individual 1,2-alkanediol and/or 2,3-alkanediol substances. Additionally, the cleaning performance of the detergent and/or cleaning composition is improved and improvements in the malodor reduction and/or coverage are observed. Surprisingly, said composition are even efficient in preventing the formation of malodor.

In a particular preferred variant, the detergent and/or cleaning composition according to the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, such hetero alkanediol mixtures have a particularly pronounced cleaning performance and remarkably improved fragrance performance along with an improved adherence. Additionally, the mixtures provide for an efficient malodor coverage and/or reduction and/or prevention.

Beside the afore-described cleaning fragrance boosting effect, the afore specified hetero mixtures or combinations comprising at least one first linear alkanediol and one or more second linear alkanediol simultaneously have also a synergistic malodor coverage and/or reduction effect, compared to the corresponding individual 1,2-alkanediol and/or 2,3-alkanediol substances.

The above specified alkanediol mixtures according to the present invention, comprising a first linear alkanediol and a second linear alkanediol, are characterized by synergistically intensified action, i.e. the alkanediol mixtures boost the fragrance performance of a detergent and/or cleaning composition in terms of intensity and adherence in a synergistic way compared to the corresponding individual 1,2-alkanediol or 2,3-alkanediol substances. Additionally, improvements in the malodor reduction and/or coverage are observed.

Still more preferred is a (fragrance) boosting agent mixture, wherein the at least first linear alkanediol is selected from a 1,2-alkanediol having a lower number of carbon atoms from 5 to 8 and the one or more second alkanediol is selected from a 1,2-alkanediol having a higher number of carbon atoms from 9 to 14.

Most preferred is a (fragrance) boosting agent mixture, wherein the at least one first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, 1,2-dodecanediol, 1,2-tridecanediol, 1,2-tetradecanediol, and any mixture thereof.

Most preferred is a (fragrance) boosting agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 13, i.e. 1,2-nonanediol, 1,2-decanediol, 1,2-undecanediol, 1,2-dodecanediol, 1,2-tridecanediol, and any mixture thereof.

Surprisingly, such hetero alkanediol mixtures of short chain alkanediols and long chain alkanediols have a particularly pronounced cleaning and fragrance boosting effect. In addition, such alkanediol mixtures are also characterized by a remarkable improved malodor coverage and/or reduction effect.

More preferred are such alkanediol mixtures, wherein the difference between the number of carbon atoms of the at least one first linear alkanediol and the number of carbon atoms of the one or more second alkanediol is at least 2 carbon atoms. In those alkanediol mixtures, short-chained and long-chained alkanediols are combined with each other resulting in improved fragrance performances in terms of intensity and adherence as well as improved malodor reduction/coverage effects.

Still more preferred is a (fragrance) boosting agent mixture, wherein the difference between the number of carbon atoms of the at least one first linear alkanediol and the number of carbon atoms of the one or more second alkanediol is at least 3 carbon atoms. With such alkanediol mixtures, the (fragrance) boosting as well as the malodor reduction/coverage effect is particularly pronounced.

Such combinations may include any of the following mixtures/combinations:
1,2-pentanediol in combination with one of 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-decanediol, 1,2-undecanediol, 1,2-dodecanediol, or 1,2-tridecanediol, or 1,2-tetradecanediol; and
1,2-octanediol in combination with one of 1,2-undecanediol, 1,2-dodecanediol, 1,2-tridecanediol, or 1,2-tetradecanediol.

In a further preferred variant according to the present invention in the detergent and/or cleaning composition the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol and mixtures thereof.

In a more preferred variant of the detergent and/or cleaning composition according to the present invention, the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and mixtures thereof. In an even more preferred variant of the detergent and/or cleaning composition according to the present invention, the linear alkanediol is selected from the group consisting of 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, 2,3-dodecanediol, 2,3-tridecanediol, and 2,3-tetradecanediol to a detergent and/or cleaning composition result in a remarkable improvement of the cleaning power and a pronounced (fragrance) boosting and malodor reduction/coverage effect, compared to the composition without the addition of an 2,3-alkanediol.

According to an alternative preferred variant, the detergent and/or cleaning composition according to the present invention comprises at least one (fragrance) boosting agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediols having a carbon chain of 5 to 8 carbon atoms, which is different from the first linear 1,2-alkanediol.

In a still more preferred variant, the detergent and/or cleaning composition according to the present invention comprises at least one (fragrance) boosting agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediols having a carbon chain of 6 to 7 carbon atoms, which is different from the first linear 1,2-alkanediol. In a further more preferred variant, the detergent and/or cleaning composition according to the present invention comprises at least one (fragrance) boosting agent selected from the group consisting of at least one linear 1,2-alkanediol having a carbon chain of 7 to 9 atoms, or a mixture comprising at least one first linear 1,2-alkanediol having a carbon chain of 7 to 9 carbon atoms and one or more second linear 1,2-alkanediol having a carbon chain of 7 to 9 carbon atoms, which is different from the first linear 1,2-alkanediol.

Surprisingly, it was found that these 1,2-alkanediols are particularly suitable (fragrance) boosting agents in terms of intensity and adhesion, which can also efficiently be incorporated into detergent and/or cleaning compositions. It was found that these substances show better cleaning results and outstanding fragrance performances. These improved properties were for example found for laundry detergents: even after long term storage of the treated textiles, the textiles show high fragrance intensities. Such detergent and/or cleaning compositions show improved cleaning and fragrance performances compared to detergent and/or cleaning composition without the addition of such substances. Additionally, improvements in view of malodor were observed.

According to a particularly preferred variant, the detergent and/or cleaning composition according to the present invention comprises at least one (fragrance) boosting agent selected from the group consisting of at least one linear 1,2-alkanediol having a carbon chain of 7 to 14 atoms, or a mixture comprising at least one first linear 1,2-alkanediol having a carbon chain of 7 to 14 carbon atoms and one or more second linear 1,2-alkanediol having a carbon chain of 7 to 14 carbon atoms, which is different from the first linear 1,2-alkanediol.

Surprisingly, it was found that these 1,2-alkanediols having a carbon chain of 7 to 14 carbon atoms are particularly efficient fragrance boosting agents, which can also efficiently be incorporated into a broad range of detergents and cleaning compositions. In addition, it was found that these substances show outstanding stain and/or soil removal enhancing properties in a detergent and cleaning composition. Thus, such detergents and/or cleaning compositions show improved cleaning properties compared to detergent and/or cleaning composition without the addition of such substances.

According to a particularly preferred variant, the detergent and/or cleaning composition according to the present invention comprises at least one (fragrance) boosting agent selected from the group consisting of at least one linear 1,2-alkanediol having a carbon chain of 9 to 14 atoms, or a mixture comprising at least one first linear 1,2-alkanediol having a carbon chain of 9 to 14 carbon atoms and one or more second linear 1,2-alkanediols having a carbon chain of 9 to 14 carbon atoms, which is different from the first linear 1,2-alkanediol.

In a more preferred variant, the detergent and/or cleaning composition according to the present invention comprises at least one (fragrance) boosting agent selected from the group consisting of at least one linear 1,2-alkanediol having a carbon chain of 10 to 13 atoms, or a mixture comprising at least one first linear 1,2-alkanediol having a carbon chain of 10 to 13 carbon atoms and one or more second linear 1,2-alkanediols having a carbon chain of 10 to 13 carbon atoms, which is different from the first linear 1,2-alkanediol.

In a still more preferred variant, the detergent and/or cleaning composition according to the present invention comprises at least one (fragrance) boosting agent selected from the group consisting of at least one linear 1,2-alkanediol having a carbon chain of 11 to 12 atoms, or a mixture comprising at least one first linear 1,2-alkanediol having a carbon chain of 11 to 12 carbon atoms and one or more second linear 1,2-alkanediols having a carbon chain of 11 to 12 carbon atoms, which is different from the first linear 1,2-alkanediol.

Surprisingly, it was found that these long-chained alkanediols are particularly suitable (fragrance) boosting agents in terms of intensity and adhesion, which can also efficiently be incorporated into a broad range of detergent and/or cleaning compositions.

Moreover, it was found that these substances show better cleaning results and outstanding fragrance performances. These improved properties were for example found for laundry detergents: even after long term storage of the treated textiles, the textiles show high fragrance intensities. Such detergent and/or cleaning compositions show considerably improved cleaning and fragrance performances compared to detergent and/or cleaning composition without the addition of such substances. Additionally, improvements in view of malodor were observed.

In a further preferred variant, the detergent and/or cleaning compositions according to the present invention comprise at least one (fragrance) boosting agent selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of $1, which is different from the first linear 1,2-alkanediol.

The 1,2-alkanediols having a log Pow value of ≤1 are selected from the group consisting of 1,2-pentanediol (log Pow=0.06), 1,2-hexanediol (log Pow=0.58), 1,2-heptanediol (log Pow=0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:

Log Pow=log 10(Partition Coefficient)

Partition Coefficient,P=[n-octanol]/[water]
where [ ] indicates the concentration of solute in the organic and/or aqueous partition.
The log Pow value is determined at a standard temperature of 25 °C.

The log Pow value ≤1 means the compound has a higher affinity for the aqueous phase (it is more hydrophilic) and, thus, more soluble in water; a log Pow value ≥1 denotes a higher concentration in the lipid phase (i.e., the compound is more lipophilic) and, thus, more soluble in fat-like solvents.

Surprisingly, it was found that 1,2-alkanediols having a Pow value of ≤1 are particularly suitable (fragrance) boosting agents within the meaning of the present invention, which can also efficiently be incorporated into a broad range of detergent and/or cleaning compositions. In addition, it was found that the aforesaid 1,2-alkanediols exhibit outstanding improved cleaning properties in a detergent and/or cleaning composition and provide for improved malodor reduction and/or coverage. Thus, detergent and/or cleaning compositions comprising 1,2-alkanediols having a Pow value of ≤1 show improved olfactory properties compared to detergent and/or cleaning composition without the addition of such 1,2-alkanediols.

In a still further preferred variant, the detergent and/or cleaning composition according to the present invention comprises at least one (fragrance) boosting agent selected from the group consisting of at least one linear 1,2-alkanediol having a log Pow value of ≥1, or a mixture comprising at least one first linear 1,2-alkanediol having a log Pow value of ≥1 and one or more second linear 1,2-alkanediol having a log Pow value of ≥1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, 1,2-dodecanediol, 1,2-tridecanediol, 1,2-tetradecanediol, and any mixture thereof. Said 1,2-alkanediols are more soluble in soluble in fat-like solvents, for example n-octanol.

Surprisingly, it was found that 1,2-alkanediols having a Pow value of ≥1 are suitable (fragrance) boosting agents, which can also efficiently be incorporated into a broad range of detergent and/or cleaning compositions and provide for improved malodor reduction and/or coverage. In addition, it was found that the aforesaid 1,2-alkanediols exhibit outstanding improved cleaning and fragrance properties in a detergent and/or cleaning composition. Thus, detergent and/or cleaning compositions comprising 1,2-alkanediols having a Pow value of ≥1 show improved olfactory properties compared to detergent and/or cleaning composition without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 14 carbon atoms or the second linear alkanediol having a carbon chain of 5 to 14 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” includes both the corresponding S-configured enantiomers and also the R-enantiomer as well as arbitrary mixtures of these S- and R-configured enantiomers, i.e. mixtures of racemates of the respective diols.

The alkanediol mixture of the detergent and/or cleaning composition according to the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the detergent and/or cleaning composition according to the present invention, 1,2-heptanediol and 2,3-heptanediol are comprised in the mixture preferably in a ratio in a range of 98:2 to 99.9:0.1.

In the detergent and/or cleaning compositions according to present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the detergent and/or cleaning composition according to the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and/or cleaning composition according to the present invention comprise 1,2-heptanediol and 2,3-heptanediol in a ratio of ≥95:≤5, including the ratios ≥95.5:≤4.5; ≥96:≤4; ≥96.5:≤3.5; ≥97:≤3; ≥97.5:2,5 and ≥98.0:≤2.0.

Even more preferred the alkanediol mixture of the detergent and/or cleaning composition according to the present invention comprises 1,2-heptanediol and 2,3-heptanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥ 99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

The at least one first linear alkanediol and the one or more second linear alkanediol as defined in detail above, are present in the alkanediol mixture according to the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the detergent and/or cleaning composition according to the present invention, the first linear alkanediol and the second linear alkanediol are comprised in the mixture preferably in a ratio in a range of 98:2 to 99.9:0.1

In the detergent and/or cleaning composition according to the present invention, the first linear alkanediol and the second alkanediol are comprised in the alkanediol mixture preferably in a ratio in a range of 95:5 to 99.9:0.1.

Preferably, the first linear alkanediol and the second alkanediol are comprised in the mixture of the detergent and/or cleaning composition according to the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and/or cleaning composition according to the present invention comprises the first linear alkanediol and the second linear alkanediol in a ratio of ≥95:≤5, including the ratios ≥95.5:≤4.5; ≥96:≤4; ≥96.5:≤3.5; ≥97:≤3; ≥97.5:2, 5 and ≥98.0:≤2.0.

Even more preferred the alkanediol mixture of the detergent and/or cleaning composition according to the present invention comprises the first linear alkanediol and the second alkanediol in a ratio of ≥98:≤2, including the ratios of ≥98.1:≤1.9; ≥98.2:≤1.8; ≥ 98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥ 99.6:≤0.4; ≥99.7:≤0.3; ≥99.8:≤0.2 and ≥99.9:≤0.1.

Alternatively, said ratio ranges for the first and second alkanediol are switched, such that the one or more second alkanediol is the main component and the at least one first alkanediol is the secondary component.

In an advantageous variant according to the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5. In a further advantageous variant according to the present invention, the alkanediol mixture comprises as first linear alkanediol an 1,2-alkanediol, such as 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a still further preferred variant, according to the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5. In a still further preferred variant, according to the present invention, the alkanediol mixture comprises as first linear alkanediol an 2,3-alkanediol, such as 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a more advantageous variant according to the present invention, in the alkanediol mixtures comprising a combination of a 1,2-alkanediol as first linear alkanediol and the corresponding 2,3-alkanediol as second linear alkanediol, such as
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,2-decanediol, or
1,2-undecanediol and 2,3-undecanediol, or
1,2-dodecanediol and 2,3-dodecanediol, or
1,2-tridecanediol and 2,3-tridecanediol, or
1,2-tetradecanediol and 2,3-tetradecanediol,
   the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol:second alkanediol or ranges of ratios as described above are also applicable.

By these mixing ratios the afore mentioned alkanediol mixtures show a synergistically intensified fragrance boosting effect in comparison with the corresponding individual substances. The same is true for the cleaning performance and malodour management.

A preferred variant according to the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to another preferred variant, the present invention relates to a detergent and/or cleaning composition as specified herein,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5; or
(ii) wherein the mixture comprising at least one first linear alkanediol and one or more second linear alkanediol, as defined herein, comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

According to a further preferred variant, the present invention relates to a detergent and/or cleaning composition as specified herein, wherein the mixture comprising at least one first linear alkanediol and one or more second linear alkanediol, as defined herein, comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

By these mixing ratios the afore mentioned mixtures show a synergistical fragrance boosting performance along with improved cleaning efficiencies and improved malodor reduction/coverage of the detergent and/or cleaning composition in direct comparison with the corresponding individual alkanediol substances.

The alkanediols are obtained either by synthesis from petrochemical or other fossil fuel sources by known methods such as olefin bis-hydroxylation, hydrolysis from epoxide or various chemical transformations or from bioderived feedstock by fermentation or from bio-based natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the further or second additional (fragrance) boosting agent of the boosting mixture (c) of the detergent and/or cleaning composition according to the present invention is either (c^{II}) glyceryl caprylate, or (c^{III}) 4-hydroxyacetophenone, or (c^{I}) ethyl hexyl glycerin, or any mixture of the aforementioned further boosting agents.

Glyceryl Caprylate, (c^{II}):

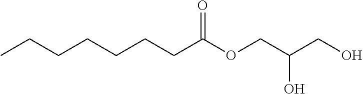

is a natural emollient derived from glycerin and plant fatty acids, usually appearing as a white waxy solid. This ingredient is used in many skincare products for its emollient and moisturizing properties, to help maintain the balance of moisture in the skin. In additional, glyceryl caprylate (c^{II}) is used as antimicrobial active component in cosmetic preparations.

It was surprisingly found that the oily, surface-active co-emulsifier glyceryl caprylate is a further suitable (fragrance) boosting agent within the meaning of the present invention.

4-Hydroxyacetophenone (4-HAP), (c^{II}):

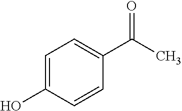

possesses oxidation-inhibiting, fungicidal and bacterial growth-inhibiting properties and is therefore used to stabilize cosmetic preparations.

It was surprisingly found that the 4-HAP is a further suitable a (fragrance) boosting agent within the meaning of the present invention.

Ethyl Hexyl Glycerin (EHG), (c^{IV}):

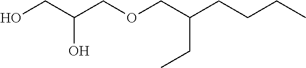

is a relatively new cosmetic ingredient that is used for its surfactant, dispersant, emollient, skin-conditioning and antimicrobial properties. Ethyl hexyl glycerin (EHG or octoxyglycerin) is a glyceryl ether and a vicinal diol.

It was surprisingly found that EHG is suitable to provide a fragrance boosting effect in detergent and/or cleaning compositions within the meaning of the present invention.

The above specified further (fragrance) boosting agents (c^{II}), (c^{II}), and (c′V) can be used either individually or in the form of mixtures of two, or even more of said (fragrance) boosting agents. Accordingly, in the boosting mixture/composition (c) at least one of the further (or second) (fragrance) boosting agents (c^{II}), (c^{III}), and (c^{IV}) is comprised as a second boosting component in addition to the at least one alkanediol component.

Similarly, the above specified (fragrance) boosting agents (c^{II}), (c^{III}), and (c^{IV}) or mixtures or two or three (fragrance) boosting agents (c^{II}), (c^{III}), and (c^{IV}) can also be used in admixture with one or two alkanediol boosting agents (c^{I}) as defined herein. Preferably, such mixtures contain two, or even more boosting agents as defined herein. Accordingly, the boosting component (c) is based on a mixture of at least one first alkanediol boosting component (first boosting agent/component) as specified above in combination with at least one further or second boosting component (further or second boosting agent/component) selected from the group consisting of glyceryl caprylate, 4-hydroxyacetophenone, ethyl hexyl glycerin or any mixture of these further boosting agents.

In a particular preferred variant, the detergent and/or cleaning composition according to the present invention the at least one (fragrance) boosting agent (c) includes any of the following mixtures/combinations:
a mixture comprising (c^{II}) glyceryl caprylate and (c^{III}) 4-hydroxyacetophenone and (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above;
a mixture comprising (c^{II}) glyceryl caprylate and (c^{IV}) ethyl hexyl glycerin and (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above;
a mixture comprising (c^{III}) 4-hydroxyacetophenone and (c^{IV}) ethyl hexyl glycerin and (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above;
a mixture comprising (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (c^{II}) glyceryl caprylate;
a mixture comprising (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (c^{III}) 4-hydroxyacetophenone;
a mixture comprising (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (c^{IV}) ethyl hexyl glycerin.

In a preferred variant, the detergent and/or cleaning composition according to the present invention includes any of the following boosting agent mixtures/combinations selected from the group consisting of:
a mixture comprising (c^{II}) glyceryl caprylate and 1,2-pentanediol;
a mixture comprising (c^{II}) glyceryl caprylate and 1,2-hexanediol;
a mixture comprising (c^{II}) glyceryl caprylate and 1,2-heptanediol;
a mixture comprising (c^{II}) glyceryl caprylate and 1,2-octanediol;
a mixture comprising (c^{II}) glyceryl caprylate and 1,2-nonanediol;
a mixture comprising (c^{II}) glyceryl caprylate and 1,2-decanediol;
a mixture comprising (c^{II}) glyceryl caprylate and 1,2-undecanediol;
a mixture comprising (c^{II}) glyceryl caprylate and 1,2-dodecanediol;
a mixture comprising (c^{II}) glyceryl caprylate and 1,2-tridecanediol;
a mixture comprising (c^{II}) glyceryl caprylate and 1,2-tetradecanediol;
a mixture comprising (c^{III}) 4-hydroxyacetophenone and 1,2-pentanediol;
a mixture comprising (c^{II}) 4-hydroxyacetophenone and 1,2-hexanediol;
a mixture comprising (c^{III}) 4-hydroxyacetophenone and 1,2-heptanediol;
a mixture comprising (c^{III}) 4-hydroxyacetophenone and 1,2-octanediol;
a mixture comprising (c^{III}) 4-hydroxyacetophenone and 1,2-nonanediol;
a mixture comprising (c^{III}) 4-hydroxyacetophenone and 1,2-decanediol;
a mixture comprising (c^{II}) 4-hydroxyacetophenone and 1,2-undecanediol;
a mixture comprising (c^{III}) 4-hydroxyacetophenone and 1,2-dodecanediol;
a mixture comprising (c^{III}) 4-hydroxyacetophenone and 1,2-tridecanediol;
a mixture comprising (c^{II}) 4-hydroxyacetophenone and 1,2-tetradecanediol;
a mixture comprising (c^{IV}) ethyl hexyl glycerin and 1,2-pentanediol;
a mixture comprising (c^{I}) ethyl hexyl glycerin and 1,2-hexanediol;
a mixture comprising (c^{IV}) ethyl hexyl glycerin and 1,2-heptanediol;
a mixture comprising (c^{IV}) ethyl hexyl glycerin and 1,2-octanediol;
a mixture comprising (c^{IV}) ethyl hexyl glycerin and 1,2-nonanediol;
a mixture comprising (c^{IV}) ethyl hexyl glycerin and 1,2-decanediol;
a mixture comprising (c^{IV}) ethyl hexyl glycerin and 1,2-undecanediol;
a mixture comprising (c) ethyl hexyl glycerin and 1,2-dodecanediol;
a mixture comprising (c^{IV}) ethyl hexyl glycerin and 1,2-tridecanediol;
a mixture comprising (c^{IV}) ethyl hexyl glycerin and 1,2-tetradecanediol.

Surprisingly, it was found that the above specified combinations are particularly efficient in terms of fragrance boost, malodor management and cleaning performance and can efficiently be incorporated into a broad range of detergent and cleaning compositions. It was found that these boosting mixtures show an outstanding synergistic boosting effect.

A particularly pronounced synergistic fragrance boosting effect and an improved malodor coverage/reduction/prevention can be observed for the following boosting agents:
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
   in combination with at least one of the following further boosting agents:
glyceryl caprylate;
4-hydroxyacetophenone;
ethyl hexyl glycerin.

An even more pronounced synergistic fragrance boosting effect and an improved malodor coverage/reduction/prevention can be observed for the following boosting agents:
1,2-nonanediol;
1,2-decanediol;
1,2-undecanediol;
1,2-dodecanediol;
1,2-tridecanediol;
1,2-tetradecanediol;
   in combination with at least one of the following further boosting agents:
glyceryl caprylate;
4-hydroxyacetophenone;
ethyl hexyl glycerin.

For the detergent and/or cleaning composition according to the present invention, the list of boosting agents ((c1.1), (c1.2), (c2.1), (c2.2), (c3.1), (c3.2), (c^{I}), (c^{II}), (c^{III}), (c^{IV}), (c)) specified herein can be arbitrary combined with the list of surfactants (a) as specified herein.

For the detergent and/or cleaning composition according to the present invention, the list of boosting agents ((c1.1), (c1.2), (c2.1), (c2.2), (c3.1), (c3.2), (c^{I}), (c^{II}), (c^{II}), (c^{IV}), (c)) specified herein can be arbitrary combined with the list of odorous substances as specified herein.

For the detergent and/or cleaning composition according to the present invention, the list of surfactants (a) as specified herein can be arbitrary combined with the list of odorous substances as specified herein.

In a particular advantageously variant, the detergent and/or cleaning composition according to the present invention comprises one of the following combinations of components (b) and (c):
extracts of natural raw fragrance materials plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
natural fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c/V) ethyl hexyl glycerin; or
synthetic fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
hydrocarbons plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c/V) ethyl hexyl glycerin; or
aliphatic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
aliphatic aldehydes and the acetals thereof plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
aliphatic ketones and the oximes thereof plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
aliphatic sulphur-containing compounds plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
aliphatic nitriles plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
esters of aliphatic carboxylic acids plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c/V) ethyl hexyl glycerin; or
acyclic terpene alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c/V) ethyl hexyl glycerin; or
acyclic terpene aldehydes and ketones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
cyclic terpene alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
cyclic terpene aldehydes and ketones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
cyclic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
cycloaliphatic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
cyclic and cycloaliphatic ethers plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
cyclic and macrocyclic ketones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
cycloaliphatic aldehydes plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c/V) ethyl hexyl glycerin; or
cycloaliphatic ketones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
esters of cyclic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{I}) ethyl hexyl glycerin; or
esters of cycloaliphatic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
esters of cycloaliphatic alcohols plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{I}) ethyl hexyl glycerin; or
esters of araliphatic alcohols and aliphatic carboxylic acids plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{I}) ethyl hexyl glycerin; or
aromatic and araliphatic aldehydes plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c/V) ethyl hexyl glycerin; or
aromatic and araliphatic ketones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin or
aromatic and araliphatic carboxylic acids and the esters thereof plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{III}) glyceryl caprylate; (c^{II}) 4-hydroxyacetophenone; or (c^{IV}) ethyl hexyl glycerin; or
nitrogenous aromatic compounds plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c/V) ethyl hexyl glycerin; or
phenols, phenyl ethers and phenyl esters plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
lactones plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin.

In a particular preferred variant, the detergent and/or cleaning composition according to the present invention comprises one of the following combinations of components (b) and (c):
natural fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
ester type fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
ether type fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
aldehyde type fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{II}) 4-hydroxyacetophenone; or (c^{IV}) ethyl hexyl glycerin; or
ketone type fragrance substances, plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
alcohol type fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin; or
hydrocarbon type fragrance substances plus the following (fragrance) boosting agents: (c^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; in combination with at least one of the following further boosting agents: (c^{II}) glyceryl caprylate; (c^{III}) 4-hydroxyacetophenone; or (c^{IV}) ethyl hexyl glycerin.

It was found that the aforesaid combinations comprising an odorous substance and a (fragrance) boosting agent mixture as specified herein result in superior fragrance performance in a detergent and/or cleaning composition, i.e. the fragrance performance of such detergent and/or cleaning compositions is better in terms of intensity and adherence than the fragrance performance of a detergent and/or cleaning composition which does not include a (fragrance) boosting agent mixture as specified herein.

However, said combinations comprising an odorous component and a (fragrance) boosting agent mixture do not only have a remarkable fragrance performance, but are simultaneously beneficial in laundry detergents, detergents for manual and automatic dishwash, hard surface cleaners, cleaners for medical and dental instruments, stain removers and the like, since they exhibit an enhanced cleaning activity combined with an improved malodor reduction and/or coverage and efficiently allow for the prevention malodor formation, resulting in an improved performance upon application, in comparison to a detergent and/or cleaning composition without the addition of said mixtures of (fragrance) boosting agents.

It is surprisingly observed that adding a mixture of boosting agents as specified above can provide for an efficient fragrance boosting effect when combined with odorous substances in a synergistical manner for detergent and/or cleaning compositions.

A particular pronounced synergistic fragrance boosting effect and improvements as specified above can be observed for the following boosting agents:
1,2-heptanediol;
1,2-octanediol;
1,2-nonanediol;
   in combination with at least one of the following further boosting agents:
glyceryl caprylate;
4-hydroxyacetophenone;
ethyl hexyl glycerin.

For the detergent and/or cleaning composition according to the present invention, the list of a boosting agents and their mixtures specified herein can be arbitrary combined with the list of surfactants specified herein.

### Optional Components

Antimicrobial Agents/Component (d), (d1), (d2), (d3):

The detergent and/or cleaning compositions can further include one or more antimicrobial agents.

The term “antimicrobial component” in the context of the present invention refers to a group of substances, in particular to agents that kills microorganisms, such as bacteria, yeast and/or fungi, or stops or inhibits their growth, which prevents products from microbial contamination. Without the addition of such agents the products spoil, which may manifest changes in smell, discoloration, mould growth, gas formation, the separation of emulsions or changes in viscosity, rendering the product unacceptable to the consumer.

Suitable antimicrobial agents include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol, phenoxyethanol. Exemplary quaternary antimicrobial agents include benzalkonium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their antimicrobial properties. Other exemplary antimicrobial agents include gluteraldehyde, Bronopol (2-bromo-2-nitropropane-1,3-diol), silver, and isothiazolones such as methylisothiazolinone, ethyl lauroyl arginate HCl, sold under the tradename Neolone™, sodium benzoate, benzyl alcohol, or methylbenzyl alcohol.

In a preferred variant according to the present invention, the detergent and/or cleaning compositions are further combined with benzyl alcohol, methylbenzyl alcohol, phenoxyethanol, and any mixture thereof. Said substances have a broad-spectrum activity against microorganisms and are added to the detergent and/or cleaning compositions to inhibit microbial spoilage, and, thus, for stabilizing purposes.

In particular, the antimicrobial agents are added to liquid detergent and/or cleaning due to their higher water content, which makes such compositions susceptible against microbial infestation and growth.

If an antimicrobial agent is included in the inventive detergent and/or cleaning compositions, it is preferably added in an amount between about 0.001% by weight and about 5% by weight, based on the total weight of the composition.

The antimicrobial component is present in the composition according to the present invention in an amount of 0.0001% to 15.0% by weight, based on the total weight of the composition. In a preferred variant, the composition comprises the antimicrobial component in an amount of 0.001% to 10.0% by weight, based on the total weight of the composition. In a particular preferred variant, the antimicrobial component is advantageously used in the composition in an amount of at 0.001% to 5.0% by weight, based on the total weight of the composition.

The detergent and/or cleaning composition according to the present invention, thus preferably comprises the at least one antimicrobial compound in an amount of 0.0001% to 15.0% by weight, particularly in an amount of 0.001% to 10.0% by weight, most particularly in an amount of 0.001% to 5.0% by weight, based on the total weight of the composition.

The activity of these antimicrobial compounds is synergistically improved based on the formulation of the compositions according to the present invention, and is particularly improved in a synergistical manner based on component (c) as specified herein.

### Enzymes and Enzyme Stabilizers:

The detergent and/or cleaning composition according to the present invention can additionally comprise at least one enzyme or an enzyme formulation, comprising at least one enzyme as further component that provides additional cleaning benefits.

Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for laundry, textiles, ware washing, cleaning-in-place, cleaning drains, floors, carpets, medical or dental instruments, meat cutting tools, hard surfaces, personal care, or the like.

Enzymes suitable for the detergent and/or cleaning compositions can act by degrading or altering one or more types of soil residues encountered on a fabric or textile thus removing the soil or making the soil more removable by a surfactant or other component of the cleaning composition. Both degradation and alteration of soil residues can improve detergency by reducing the physicochemical forces that bind the soil to the instrument or device being cleaned, e.g., the soil becomes more water soluble. For example, one or more proteases can cleave complex, macro molecular protein structures present in soil residues into simpler short chain molecules which are, of themselves, more readily desorbed from surfaces, solubilized or otherwise more easily removed by detersive solutions containing said proteases.

Detersive enzymes according to the present invention have a cleaning, destaining or otherwise beneficial effect as a component of a detergent and/or cleaning composition for instruments, devices, or equipment, such as medical or dental instruments, devices, or equipment; or for laundry, textiles, ware-washing, cleaning-in-place, drains, carpets, meat cutting tools, hard surfaces, personal care, or the like.

Enzymes that can be used according to the present invention include enzymes that provide desirable activity for removal of protein-based, carbohydrate-based, or triglyceride-based stains from substrates; for cleaning, destaining, and sanitizing presoaks, such as presoaks for medical and dental instruments, devices, and equipment; presoaks for flatware, cooking ware, and table ware; or presoaks for meat cutting equipment; for machine ware washing; for laundry and textile cleaning and destaining; for carpet cleaning and destaining; for cleaning-in-place (CIP) and destaining-in-place; for cleaning and destaining food processing surfaces and equipment; for drain cleaning; presoaks for cleaning; and the like.

Suitable enzymes used according to the present invention are selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including Dnase and/or Rnase), phenoloxidases, lipoxygenases, ligninases, pullulanases, tannases, pentosanases, malanases, β-glucanases, arabinosidases, hyaluronidases, chondroitinase, oxidoreductase, and any mixture thereof.

The enzymes used according to the present invention are of any suitable origin, such as vegetable, animal, bacterial, fungal or yeast origin.

Proteases: Any protease or mixture of proteases, from any source, can be used in the detergent and/or cleaning compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, and Progress UNO™, Liquanase® and Pristine®, each available from Novozymes; and Preferenz® P and Excellenz® P, each available from DUPONT/IFF.

Amylases: Any amylase or mixture of amylases, from any source, can be used in the detergent and/or cleaning compositions, provided that the selected enzyme is stable in the desired pH range (between about 6 and about 9). For example, the amylase enzymes can be derived from a plant, an animal, or a microorganism such as a yeast, a mold, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Lipases: Any lipase or mixture of lipases, from any source, can be used in the detergent and/or cleaning compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes, and Preferenz® L, available from DUPONT/IFF.

Cellulases: Any cellulase or mixture of cellulases, from any source, can be used in the detergent and/or cleaning compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusc, Dolabella Auricula Solander. The cellulase can be purified or a component of a microbial extract, and either wild type or variant (either chemical or recombinant). Preferred cellulases are commercially available under the trade names Celluclean® and Carezyme®, each available from Novozymes; and Revitalenz®, available from DUPONT/IFF.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes, amylase enzymes and lipase enzymes are the most used enzymes in detergent and/or cleaning compositions. The protease enzymes are particularly advantageous for cleaning soils containing protein, e.g. egg, milk, meat residue, or the like. The amylase enzymes are particularly advantageous for removing starch-based soils, such as pasta and rice. The lipase enzymes are particularly advantageous for cleaning soils including fat/grease.

As one skilled in the art shall ascertain, enzymes are designed to work with specific types of soils. For example, according to an embodiment of the invention, ware wash applications may use a protease enzyme as it is effective at the high temperatures of the ware wash machines and is effective in reducing protein-based soils. Protease enzymes are particularly advantageous for cleaning soils containing protein, such as blood, cutaneous scales, mucus, grass, food (e.g. egg, milk, spinach, meat residue, tomato sauce), or the like.

According to the invention, the enzyme contained in detergent and/or cleaning composition may be varied based on the particular cleaning application and the types of soils in need of cleaning. For example, the temperature of a particular cleaning application will impact the enzymes selected for an enzyme composition according to the invention. Ware wash applications, for example, clean substrates at temperatures in excess of approximately 60 °C, or in excess of approximately 70 °C, or between approximately 65 °C to 80 °C, and enzymes such as proteases are desirable due to their ability to retain enzymatic activity at such elevated temperatures.

Laundry applications, for example, clean laundry at temperatures in excess of approximately 40 °C, or in excess of approximately 50 °C, or between approximately 65 °C to 95 °C, and enzymes such as proteases are desirable due to their ability to retain enzymatic activity at such elevated temperatures.

In a variant of the present invention, the enzyme in the detergent and/or cleaning composition is a single enzyme. In some other variants, the enzyme in the detergent and/or cleaning composition is preferably an enzyme cocktail of two, three, four or even more different enzymes. Preferably, laundry detergents contain from two (preferably protease and amylase) to five or even to six enzymes.

Preferably, the at least one enzyme is selected from the group consisting of a protease, an amylase, a lipase, a gluconase, a cellulase, a peroxidase, or a mixture thereof.

In some variants, the enzyme in the composition is a protease, an amylase, a lipase, a cellulase, a gluconase, a peroxidase, a mannanase, or any mixture thereof.

Preferably the enzyme is a mixture of protease, an amylase, a lipase, a cellulase and/or pectate lyase.

Preferred detersive enzymes include a hydrolase such as a protease, an amylase, a lipase, or a combination thereof.

Preferably, the enzyme is a protease, amylase, lipase, cellulose, peroxidase, gluconase, or any mixture thereof.

In a still preferred variant, the enzyme in the detergent and/or cleaning compositions disclosed here is a protease, amylase, lipase, or any mixture thereof.

Still more preferred, the enzyme is a protease, an amylase, or a mixture thereof.

Still more preferred, the enzyme is a protease, a lipase, or a mixture thereof.

Still more preferred, the enzyme is selected from an amylase, a lipase, or a mixture thereof.

In some other embodiments, the enzyme is a protease.

In yet some other variant, the enzyme is an amylase.

In yet some other variant, the enzyme is a lipase.

In yet some other variant, the enzyme is a cellulase.

Preferred enzymes in solid detergent and/or cleaning compositions according to the present invention include a protease, an amylase, a lipase, a cellulase, or a combination thereof.

Preferred enzymes in detergent and/or cleaning compositions according to the present invention for cleaning medical or dental devices or instruments include a protease, an amylase, a cellulase, a lipase, or a combination thereof.

Preferred enzymes in detergent and/or cleaning compositions according to the present invention for food processing surfaces and equipment include a protease, a lipase, an amylase, a gluconase, or a combination thereof.

Preferred enzymes in detergent and/or cleaning compositions according to the present invention for laundry or textiles include a protease, a cellulase, a lipase, a peroxidase, or a combination thereof. Preferred enzymes in detergent and/or cleaning compositions for carpets include a protease, an amylase, or a combination thereof.

Preferred enzymes in detergent and/or cleaning compositions according to the present invention for meat cutting tools include a protease, a lipase, or a combination thereof.

Preferred enzymes in detergent and/or cleaning compositions according to the present invention for hard surfaces include a protease, an amylase, a lipase, or a combination thereof.

Preferred enzymes in detergent and/or cleaning compositions according to the present invention for drains include a protease, an amylase, a lipase, or a combination thereof.

For a stain remover, the enzymes are preferably selected from the group consisting of protease, amylase, lipase, mannanase, pectate lyase, and any mixture thereof.

For a fabric softener, the enzyme is preferably cellulase.

In order to increase the bleaching effect, oxidoreductases are added to the detergent and/or cleaning composition according to the present invention.

The oxidoreductases are selected from the group consisting of oxidases, oxygenases, catalases, peroxidases, such as halo-, chloro-, bromo-, lignin-, glucose- or manganese-peroxidases, dioxygenases or laccases, such as phenoloxidases and polyphenoloxidases, and any mixture thereof.

Enzymes are typically not used in combination with bleaching agents in liquid detergent and/or cleaning compositions as they are not stable (enzyme denaturation) but in powdered compositions percarbonate and enzymes are typically added.

Commercial enzymes are obtainable in liquid or dried form (i.e. puck, powder, etc.), are sold as raw aqueous solutions or in assorted purified, processed and compounded forms established in the prior art, and include about 0.1% to about 80% by weight active enzyme generally in combination with stabilizers, buffers, cofactors, impurities and inert vehicles. The actual active enzyme content depends upon the method of manufacture and is not critical; assuming the solid detergent and/or cleaning composition has the desired enzymatic activity.

Preferably, the enzyme(s) are added to the detergent and/or cleaning compositions either as single enzyme formulation, as enzyme cocktail formulation comprising a mixture of different enzymes or still more preferred as formulation in admixture with stabilizers, preferably with one or more enzyme stabilizers, buffers, and the like.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers and are storage-stable on account of the coating. Furthermore, it is possible to package two or more enzymes together so that a single granulate exhibits multiple enzyme activities.

In a preferred variant according to the present invention, the enzyme is added to the detergent and/or cleaning composition as a single enzyme.

In some other variants, the enzyme added to the detergent and/or cleaning composition is preferably an enzyme cocktail of two, three, four or even more different enzymes. Typically, for laundry detergents an enzyme cocktail contains from two (preferably protease and amylase) to six enzymes.

The enzyme(s) is/are normally incorporated into the detergent and/or cleaning composition according to the disclosure in an amount sufficient to yield effective cleaning during a washing procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening deodorizing, or freshness improving effect on substrates such as medical or dental devices or instruments and the like. Such a cleaning effect can be achieved with amounts of enzyme as low as about 0.02% by weight of the detergent and/or cleaning composition.

In the detergent and/or cleaning compositions of the present disclosure, suitable cleaning can typically be achieved when an enzyme is present at about 0.0001% to about 35% by weight; preferably about 2% to about 15% by weight; preferably about 3% to about 10% by weight; preferably about 4% to about 8% by weight; preferably about 4%, about 5%, about 6%, about 7%, or about 8% by weight, based on the total weight of the composition. The higher enzyme levels are typically desirable in highly concentrated cleaning formulations.

In the detergent and/or cleaning compositions of the present disclosure, suitable cleaning can typically be achieved when an enzyme is present in an amount of 0.0001% to 5% by weight, based on the total weight of the composition. Preferably, the enzyme is present in an amount of 0.0001% to 4% weight, based on the total weight of the composition. More preferred the detergent and/or cleaning composition according to the present invention comprises the enzyme in an amount of 0.001% to 3% by weight, based on the total weight of the composition. Most preferred the enzyme is present in the detergent and/or cleaning composition in an amount of 0.01% to 2% by weight, based on the total weight of the composition. Further preferred the enzyme is present in the detergent and/or cleaning composition in an amount of 0.05% to 2% by weight, based on the total weight of the composition.

Typically, the enzyme is present in the detergent and/or cleaning composition according to the present invention in an amount of 0.05% to 2.0% by weight. Usually, proteases and amylase are used in higher concentrations in the detergent and/or cleaning compositions, namely proteases in an amount of 0.4% to 1.5% by weight, amylases in an amount of 0.05% to 0.6% by weight, based on the total weight of the composition.

For an enzyme cocktail the above amounts relate to the total content of the enzymes in the mixture, i.e. the amount is the sum of the content of all enzymes in the mixture.

### Enzyme Stabilizer:

The detergent and/or cleaning composition according to the present invention optionally comprises at least one enzyme stabilizer, to further stabilize the enzyme in the detergent and/or cleaning composition from loss of activity (i.e. retain proteolytic activity or enzymatic retention). The enzymes are stabilized by the further enzyme stabilizer through a physical protection by means of a protective layer.

In a more preferred variant, the at least one enzyme is added to the detergent and/or cleaning composition according to the present invention as enzyme formulation in mixture with one or more stabilizer(s), preferably with one or more enzyme stabilizers, and optionally buffers, additives, and the like. Suitable enzyme stabilizers are known to the person skilled in the art.

The enzyme formulation with the enzyme stabilizer is added to the detergent and/or cleaning composition in such amounts, that the enzyme stabilizer is present in the detergent and/or cleaning composition in an amount of 0.0001% to 5% by weight, based on the total weight of the detergent and/or cleaning composition. Preferably, the enzyme stabilizer is present in an amount of 0.001% to 4% by weight, based on the total weight of the detergent and/or cleaning composition. Most preferred, the detergent and/or cleaning composition includes the enzyme stabilizer in an amount of 0.01% to 3% by weight, based on the total weight of the composition.

### Optional Further Components

Within the context of the present invention, it is also possible, and in some cases advantageous, to combine the detergent and/or cleaning compositions according to the present invention with other active substances and/or additives, depending on the purpose of the composition, in order to obtain a ready-for-use composition or formulation. The active ingredients provide the desired properties and functionalities to the detergent and/or cleaning compositions according to the present invention. The term “functional ingredient” or “functional additive” includes an ingredient that provides a beneficial property in a particular use. Some particular examples of functional ingredients are discussed in more detail below. However, a broad variety of other functional ingredients may be used.

The detergent and/or cleaning compositions according to the present invention may comprise any of the ingredients customarily found in such compositions, such as, for example organic solvents, builders, and additional auxiliaries such as soil repellents, thickeners, colorants and fragrances or the like.

Preferably, the detergent and/or cleaning composition according to the present invention can advantageously be combined or varied with at least one active substance and/or at least one (functional) additive, such as for example anti-static agents, anti-wrinkling agents, antimicrobial agents, dye transfer inhibition agents (dye transfer inhibiting agents or dye transfer inhibitors)/color protection agents, dye scavengers, dyes/coloring agents, greying inhibitors, odor removal/odor capturing agents, soil shielding/soil releasing agents, anti-redeposition agents, ultraviolet light protection agents, sanitizing agents, disinfecting agents, water repellency agents, insect repellency agents, anti-pilling agents, souring agents, mildew removing agents, allergicide agents, solubility modifiers, rheology modifiers/viscosity modifiers or thickeners, dispersing agents, water softeners, buffers, (organic) solvents, defoamers/foam inhibitors/suds suppressor, foam stabilizers, fabric softeners, starch agents, bleaching compounds/agents, bleach activators, bleach catalysts and bleach stabilizers, bleach scavengers, optical brighteners and ultraviolet light adsorbers, chelating agents/sequestrant agents (sequestrants), builders, co-builders, pH adjusters, stabilizers, hydrotropes, preservatives, fire proofing agents, shrinkage controllers, (inorganic) salts, and any mixtures thereof.

Boosting agents (c) within the meaning of the present invention are mixtures of (c1.1) 1,2-heptanediol, (c2.1) 2,3-heptanediol, (c3.1) a mixture of 1,2-heptanediol and 2,3-heptanediol, or (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol with (c^{II}) glyceryl caprylate and/or (c^{III}) 4-hydroxyacetophenone and/or (c^{IV}) ethyl hexyl glycerin. Preferably, boosting agents (c) within the meaning of the present invention are mixtures of (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol with (c^{II}) glyceryl caprylate and/or (c^{II}) 4-hydroxyacetophenone and/or (c^{IV}) ethyl hexyl glycerin.

Accordingly, the boosting component (c) is based on a mixture of a first alkanediol boosting component as specified herein and at least one second boosting component selected from the group consisting of glyceryl caprylate, 4-hydroxyacetophenone, ethyl hexyl glycerin or any mixture thereof.

The 1,2-heptanediol (c1.1) or the 2,3-heptanediol (c2.1) or the mixture comprising 1,2-heptanediol and 2,3-heptanediol (c3.1) according to the present invention is present in the detergent and/or cleaning composition in an amount of 0.001% to 15.0% by weight, based on the total weight of the composition. In a preferred variant, the detergent and/or cleaning composition comprises the 1,2-heptanediol (c1.1) or the 2,3-heptanediol (c2.1) or the mixture comprising 1,2-heptanediol and 2,3-heptanediol (c3.1) in an amount of 0.01% to 10.0% by weight, based on the total weight of the composition. In a more preferred variant, the 1,2-heptanediol (c1.1) or 2,3-heptanediol (c2.1) or the mixture comprising 1,2-heptanediol and 2,3-heptanediol (c3.1) is advantageously used in the detergent and/or cleaning composition in an amount of at 0.1% to 5.0% by weight, based on the total weight of the composition. In a still more preferred variant, the 1,2-heptanediol (c1.1) or 2,3-heptanediol (c2.1) or the mixture comprising 1,2-heptanediol and 2,3-heptanediol (c3.1) is advantageously used in the detergent and/or cleaning composition in an amount of at 0.3% to 3.0% by weight, based on the total weight of the composition. In a most preferred variant, the 1,2-heptanediol (c1.1) or 2,3-heptanediol (c2.1) or the mixture comprising 1,2-heptanediol and 2,3-heptanediol (c3.1) is advantageously used in the detergent and/or cleaning composition in an amount of at 0.5% to 1.0% by weight, based on the total weight of the composition.

For the heptanediol mixture (c3.1), the above amounts relate to the total content of the 1,2-heptanediol and the 2,3-heptanediol in the mixture, i.e. the amount is the sum of the content of 1,2-heptanediol and 2,3-heptanediol in the mixture.

The at least one first component of the boosting component or mixture (c), i.e. the alkanediol component (c^{I}) according to the present invention is present in the detergent and/or cleaning composition in an amount of 0.001% to 15.0% by weight, based on the total weight of the composition. In a preferred variant, the detergent and/or cleaning composition comprises the at least one alkanediol boosting component (c^{I}) in an amount of 0.01% to 10.0% by weight, based on the total weight of the composition. In a more preferred variant, the at least one alkanediol boosting component (c^{I}) is advantageously used in the detergent and/or cleaning composition in an amount of at 0.1% to 5.0% by weight, based on the total weight of the composition. In a still more preferred variant, the at least one alkanediol boosting component (c^{I}) is advantageously used in the detergent and/or cleaning composition in an amount of at 0.3% to 3.0% by weight, based on the total weight of the composition. In a most preferred variant, the at least one alkanediol boosting component (c^{I}) is advantageously used in the detergent and/or cleaning composition in an amount of at 0.5% to 1.0% by weight, based on the total weight of the composition.

For the alkanediol mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol and the second linear alkanediol in the mixture.

In a particular preferred variant according to the present invention, the detergent and/or cleaning composition comprises the 2,3-heptanediol or the 2,3-heptanediol of the mixture comprising 1,2-heptanediol and 2,3-heptanediol (c3.1) in an amount of 0.001% to 15.0% by weight, preferred in an amount of 0.01 to 10.0% by weight, more preferred in an amount of 0.1% to 5.0% by weight, still more preferred in an amount of 0.3% to 3.0% by weight, and most preferred in an amount of 0.5% to 1.0% by weight, based on the total weight of the composition.

Even more preferred, the detergent and/or cleaning composition comprises the 2,3-heptanediol or the 2,3-heptanediol of the mixture comprising 1,2-heptanediol and 2,3-heptanediol (c3.1) in an amount of 0.001% to 0.5% weight, preferably in an amount of 0.005% to 0.1% by weight and most preferably in an amount of 0.01% to 0.075% by weight, based on the total weight of the composition or detergent and/or cleaning product.

In a particular preferred variant according to the present invention, the detergent and/or cleaning composition comprises the 2,3-alkanediol as the at least one linear alkanediol or of the mixture comprising at least one first linear alkanediol and one or more second linear alkanediol in an amount of 0.001% to 15.0% by weight, preferably in an amount of 0.01% to 10.0% by weight, more preferred in an amount of 0.1% to 5.0% by weight, still more preferred in an amount of 0.3% to 3.0% by weight, and most preferred in an amount of 0.5 to 1.0% by weight, based on the total weight of the composition or detergent and/or cleaning product.

Even more preferred, the detergent and/or cleaning composition comprises the 2,3-alkanediol as the at least one linear alkanediol or of the mixture comprising at least one first linear alkanediol and one or more second linear alkanediol in an amount of 0.001% to 0.5% weight, preferably in an amount of 0.005% to 0.1% by weight and most preferably in an amount of 0.01% to 0.075% by weight, based on the total weight of the composition or detergent and/or cleaning product.

The at least one second component of the boosting component or mixture (c), i.e. the (c^{II}) glyceryl caprylate and/or (c^{III}) 4-hydroxyacetophenone and/or (c^{IV}) ethyl hexyl glycerin (also referred to as (c1.2), (c2.2), (c3.2)) according to the present invention is/are present in the detergent and/or cleaning composition in an amount of 0.001% to 15.0% by weight, based on the total weight of the composition. In a preferred variant, the detergent and/or cleaning composition comprises the (c^{II}) glyceryl caprylate and/or (c^{III}) 4-hydroxyacetophenone and/or (c^{IV}) ethyl hexyl glycerin in an amount of 0.01% to 10.0% by weight, based on the total weight of the composition. In a more preferred variant, the detergent and/or cleaning composition comprises the (c^{II}) glyceryl caprylate and/or (c^{III}) 4-hydroxyacetophenone and/or (c^{IV}) ethyl hexyl glycerin in an amount of 0.1% to 5.0% by weight, based on the total weight of the composition. In a still more preferred variant, the (c^{II}) glyceryl caprylate and/or (c^{II}) 4-hydroxyacetophenone and/or (c^{IV}) ethyl hexyl glycerin is advantageously used in the detergent and/or cleaning composition in an amount of at 0.3% to 3.0% by weight, based on the total weight of the composition. In a most preferred variant, the (c^{II}) glyceryl caprylate and/or (c^{II}) 4-hydroxyacetophenone and/or (c^{IV}) ethyl hexyl glycerin is advantageously used in the detergent and/or cleaning composition in an amount of at 0.5% to 1.0% by weight, based on the total weight of the composition.

For the mixture of two or more further boosting agents, the above amounts relate to the total content of further boosting agents in the mixture, i.e. the amount is the sum of the content of the single further boosting agents in the mixture.

Preferably, the detergent and/or cleaning composition comprises the boosting component (c), i.e. a mixture of at least one (first) alkanediol boosting component (at least one boosting agent) as specified herein and at least one second boosting component (at least one further boosting agent) selected from the group consisting of glyceryl caprylate, 4-hydroxyacetophenone, ethyl hexyl glycerin or any mixture thereof in an amount of 0.001% to 15.0% by weight, based on the total weight of the composition, and further preferred in an amount of 0.01% to 10.0% by weight, based on the total weight of the composition, and even more preferred in an amount of 0.1% to 5.0% by weight, based on the total weight of the composition. In a still more preferred variant, the boosting component (c) is advantageously used in the detergent and/or cleaning composition in an amount of at 0.3% to 3.0% by weight, based on the total weight of the composition. In a most preferred variant, the boosting component (c) is advantageously used in the detergent and/or cleaning composition in an amount of at 0.5% to 1.0% by weight, based on the total weight of the composition.

Accordingly, the detergent and/or cleaning composition according to the present invention thus preferably comprises a mixture of the at least one boosting agent (c^{I}) and the at least one further boosting agent selected from the group consisting of (c^{II}), (c^{III}), (c^{IV}), and any mixtures of these further boosting agents, in an amount of 0.001% to 15.0% by weight, preferred in an amount of 0.01% to 10.0% by weight, more preferred in an amount of 0.1% to 5.0% by weight, still more preferred in an amount of 0.3 to 3.0% by weight, most preferred in an amount of 0.5% to 1.0% by weight, based on the total weight of the composition.

For the boosting component (c), i.e. the mixture of boosting agents as specified herein the above amounts relate to the total content of the boosting agents in the composition, i.e. the amount is the sum of the content of all boosting agents in the composition (alkanediol boosting agents plus further boosting agents).

Typically, the at least one surfactant (a), (a1), (a2), (a3) is present in the detergent and/or cleaning composition according to the present invention in an amount of 0.001% to 90% by weight, based on the total weight of the composition. Preferably, the surfactant is present in an amount of 0.001% to 60% by weight, based on the total weight of the composition. More preferred, the detergent and/or cleaning composition according to the present invention comprises the surfactant in an amount of 0.01% to 50% by weight and most preferred in an amount of 0.1% to 40% by weight, based on the total weight of the composition.

By contrast, light-duty compositions according to the present invention comprise the at least one surfactant in an amount of 0.001% to 40% by weight, based on the total weight of the composition. Preferably, the at least one surfactant is present in an amount of 0.005% to 30% by weight, based on the total weight of the composition. The detergent and/or cleaning composition according to the present invention preferably comprises the surfactant in an amount of 0.01% to 25% by weight and preferred in an amount of 0.1% to 20% by weight, based on the total weight of the composition.

For a surfactant mixture the above amounts relate to the total content of the surfactants in the mixture, i.e. the amount is the sum of the content of all surfactants in the mixture.

In detergent and/or cleaning compositions, the at least one odorous substance or mixture of odorous substances (component (b), (b1), (b2), (b3)) is preferably comprised in amounts of around 0.00001% to 10% by weight, preferably 0.0001% to 5% by weight and particularly preferably 0.001% to 2% by weight, relative to the total amount of the detergent and/or cleaning compositions.

The at least one antimicrobial compound (component (d), (d1), (d2), (d3)) is preferably present in the composition according to the present invention in an amount of 0.0001% to 15.0% by weight, based on the total weight of the composition. In a preferred variant, the composition comprises the antimicrobial component in an amount of 0.001% to 10.0% by weight, based on the total weight of the composition. In a particular preferred variant, the antimicrobial component is advantageously used in the composition in an amount of at 0.001% to 5.0% by weight, based on the total weight of the composition.

The detergent and/or cleaning composition according to the present invention, thus preferably comprises the at least one antimicrobial compound in an amount of 0.0001% to 15.0% by weight, particularly in an amount of 0.001% to 10.0% by weight, most particularly in an amount of 0.001% to 5.0% by weight, based on the total weight of the composition.

Detergent and/or Cleaning Compositions and Products Thereof

According to a further aspect of the present invention, the detergent and/or cleaning composition according to the present invention is used as such (i.e. as a detergent and/or cleaning product) or for the preparation of a detergent and/or cleaning product or a detergent and/or cleaning formulation.

The detergent and/or cleaning compositions of the current disclosure are found, surprisingly, to have a superior cleaning performance and simultaneously show efficient malodor coverage and/or malodor reduction properties, compared to compositions without the addition of an inventive boosting agent mixture. In addition, it was found that the compositions according to the present invention are efficient in preventing the formation of malodor.

Additionally, it was surprisingly found that the detergent and/or cleaning compositions according to the present invention, boost the olfactory properties of odorous substances and/or the adherence of odorous substances comprised in said detergent and/or cleaning compositions, compared to compositions without the addition of an inventive boosting agent mixture. This results in improved intensities even when using small amounts of the odorous component.

In addition, the malodor reduction and/or malodor coverage performance of the detergent and/or cleaning compositions is further improved based on the combination of at least one boosting composition based on the combination of at least one alkanediol boosting agent and at least one further boosting agent selected from the group consisting of glyceryl caprylate, 4-hydroxyacetophenone, ethyl hexyl glycerin, or any mixture of these further boosting agents as specified herein, a surfactant component, an odorous fragrance component as well as an optional additional antimicrobial component in a synergistical manner.

Surprisingly, it has been found that the addition of an effective amount of a mixture of at least one alkanediol as specified herein as a first boosting component with glyceryl caprylate, 4-hydroxyacetophenone, ethyl hexyl glycerin, or any mixture thereof as a second/further boosting component, as defined herein, to a detergent and/or cleaning composition has a positive influence in that they synergistically enhance the cleaning efficiency and/or malodor reduction/coverage of a detergent and/or cleaning composition and/or the olfactory properties of odorous substances comprised therein and/or the adherence of odorous substances comprised therein. The fragrance substance(s) in these detergent and/or cleaning compositions show(s) a superior olfactory performance in terms of intensity and adhesion, compared to detergent and/or cleaning compositions without such a boosting composition. Moreover, it was surprisingly found that the combination of an alkanediol component as a first boosting component with a second/further boosting component selected from the group consisting of glyceryl caprylate, 4-hydroxyacetophenone, or ethyl hexyl glycerin, or any mixture thereof synergistically boost (or improve) the malodor reduction and/or malodor coverage performance of the detergent and/or cleaning compositions.

Thus, the detergent and/or cleaning compositions which contain an odorous substance or a mixture of odorous substances in combination with a mixture of 1,2-heptanediol or 2,3-heptanediol or a mixture comprising 1,2-heptanediol and 2,3-heptanediol or at least one alkanediol as specified herein with glyceryl caprylate, 4-hydroxyacetophenone, and/or ethyl hexyl glycerin, as defined herein, exhibit improved overall olfactory performance over detergent and/or cleaning compositions without such a fragrance boosting composition (c).

Conversely, also because of the boosting effect, the amount of fragrances and other ingredients for increasing the fragrance performance or cleaning performance or malodor management performance in these detergent and/or cleaning compositions can be reduced while achieving a similar cleaning effect, i.e. without loss of fragrance performance or cleaning performance.

Moreover, the detergent and/or cleaning compositions which contain an odorous substance or a mixture of odorous substances in combination with a mixture of 1,2-heptanediol or 2,3-heptanediol or a mixture comprising 1,2-heptanediol and 2,3-heptanediol or alkanediols as specified herein with glyceryl caprylate, 4-hydroxyacetophenone, and/or ethyl hexyl glycerin, as defined herein, exhibit improved malodor reduction properties and allow for the efficient coverage of malodor. Furthermore, these compositions were found to additionally prevent the formation of malodor.

Conversely, also because of the boosting effect, the amount of additives such as malodor reducers and other ingredients for improving the olfactory impression can be reduced without loss of cleaning performance.

The combination of the boosting agents selected from the group of alkanediols with at least one further boosting components selected from the group consisting of glyceryl caprylate, 4-hydroxyacetophenone, and ethyl hexyl glycerin in a detergent and/or cleaning composition provides for an improved feeling of freshness and cleanness. Especially, the detergent and/or cleaning compositions according to the present invention are particularly beneficial in preventing or minimizing or covering malodor. It was surprisingly found that these boosting components act in a synergistic manner.

According to a further aspect of the present invention, the detergent and/or cleaning composition according to the present invention is used as such, or for the preparation of a detergent and/or cleaning product.

The detergent and/or cleaning compositions or products as specified herein can be employed in a variety of washing or cleaning methods. As used herein, the term “cleaning” refers to perform, facilitate, or aid in soil removal, bleaching, etc. Preferably, the detergent and/or cleaning compositions or products are useful for textile cleaning, laundry, dishwashing, fabric care, for household, institutional and industrial hard surfaces cleaning, such as ware or other surfaces, cleaning medical and dental instruments, etc.

As used herein, the term “fabric cleaning” includes detergent and/or cleaning compositions designed for cleaning stained and/or soiled material. Such formulations include such compositions but are not limited to, laundry detergent compositions, fabric softening compositions, fabric enhancing compositions, fabric freshening compositions, laundry prewash, laundry pretreat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibers preferably said fibers including active agents, and other suitable forms that may be apparent to one skilled in the art.

As used herein, the term “fabric care” relates to various fabric benefits including smoothness, shape maintenance, resilience, color preservation, pilling control and others.

The term “ware” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a tool, a machine, equipment, a structure, or the like, that is employed as part of a food processing, preparation or storage activity. The term “ware” in the context of the present invention refers to items such as eating and cooking utensils, dishes, and other hard surfaces such as showers, sinks, toilets bathtubs, countertops, windows, mirrors, and floors.

Preferably, the detergent and/or cleaning compositions or products can be employed for cleaning, washing, or presoaking medical or dental devices, instruments, or equipment, including any of the various medical or dental instruments or devices that can benefit from cleaning with enzyme cleaning compositions. Exemplary medical and dental instruments and devices include instruments, devices, tools, appliances, apparatus, and equipment used in medicine or dentistry including those than can be cold sterilized, soaked or washed and then heat sterilized. The medical and/or dental instruments can be soiled with blood, mammalian tissue, including but not limited to human tissue, or other foreign matter.

Suitable examples of detergent and/or cleaning compositions or products encompass heavy-duty detergents, color-care detergents, light-duty detergents, all-purpose washing agents, fabric softeners, fabric laundry scents, scent lotions, laundry wipes, stain removers (pre-spotter, Vanish type), washing machine cleaners, all-purpose cleaners, hand dishwashing detergents, auto dishwashing detergents, hard surface cleaners, glass and mirror cleaners, wet cleaning wipes, kitchen cleaners, cleaners for cooking appliances, oven cleaners, floor cleaners, wood floor cleaners, carpet cleaners, bathroom and shower cleaners, toilet cleaners, grout cleaners, disinfectants, drain unblockers, toilet rim block gels, air fresheners, furniture polish, car shampoo, medical cleaning products, and the like.

In a preferred variant, the detergent and/or cleaning composition is a stain remover (pre-spotter, Vanish type).

The afore-mentioned detergent and/or cleaning compositions or products refer to a detergent and/or cleaning composition in the form of a liquid, a solid, tablets, encapsulated, diluted or concentrated form and optionally in two-compartment or multi-compartment form.

Thus, based on the beneficial properties of the compositions disclosed herein the present invention further relates to a detergent and/or cleaning product comprising the detergent and/or cleaning compositions according to the present invention.

The afore-mentioned products preferably refer to a detergent and/or cleaning composition in the form of a liquid, a solid, gelled, bar, paste, spray, tablet, encapsulated, diluted or concentrated form and optionally in two-compartment or multi-compartment form.

As used herein, a liquid includes free-flowing liquids, as well as pastes, gels, foams and mousses. Non-limiting examples of liquids include light-duty and heavy-duty liquid detergent and/or cleaning compositions, fabric enhancers, detergent gels commonly used for laundry, bleach and laundry additives. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art.

A solid detergent and/or cleaning composition or product can be provided as a pressed solid block, a cast solid block, an extruded pellet or block, or a tablet. Furthermore, a solid detergent composition or product may be provided in the form of a unit dose. A unit dose refers to a solid detergent and/or cleaning composition unit sized so that the entire unit is used during a single washing cycle.

A solid detergent and/or cleaning composition or product may also be provided in the form of a multiple use (e.g., multi-use) solid, such as, a block or a plurality of pellets, and can be repeatedly used to generate aqueous use solutions of the detergent composition for multiple cycles or a predetermined number of dispensing cycles. A multiple use solid detergent composition can be repeatedly used to generate an aqueous detergent composition, e.g., use solution, for multiple washing cycles. Pressed solid detergent blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid detergent blocks are made by using a binding system to minimize any damage to the coated granules which may be employed. Beneficially, a pressing process to make the pressed solid detergent blocks generates a pressed solid detergent block and prevents the reaction or mix of the components. In an aspect of the disclosure, the solid detergent composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mould or container). The method can include gently pressing the flowable solid in the form to produce the solid cleaning composition.

The detergent and/or cleaning compositions or products can be provided in concentrated form and diluted to a use solution or provided in a use solution. Preferably, the use compositions are diluted to a concentration between about 500 ppm and about 5000 ppm, more preferably between about 750 ppm and about 4500 ppm, most preferably between about 1000 ppm and about 4000 ppm.

The detergent and/or cleaning compositions or products according to the present invention are used for household cleaning, medical cleaning, institutional cleaning, such as cleaning in schools, airport, hospitals, or industrial cleaning.

The detergent and/or cleaning compositions or products according to the present invention can be prepared by combining and mixing the various ingredients according to usual and known methods. Preferably, the enzyme is added last to prevent denaturation or inactivation of the enzyme. Mixing can be performed by any suitable automatic or manual method. For example, automatic or manual stirring can be performed. The detergent and/or cleaning such as detergent compositions can be prepared in batch or continuous process.

Based on its afore described advantageously effects, the detergent and/or cleaning composition according to the present invention, comprising a combination of at least one odorous substance and a fragrance boosting composition based on the mixture of at least one alkanediol with glyceryl caprylate, 4-hydroxyacetophenone, and/or ethyl hexyl glycerin, is particularly efficient in washing and cleaning processes for boosting the cleaning efficiency of a detergent and/or cleaning composition and/or boosting the olfactory properties of odorous substances comprised therein and/or for boosting the adherence of odorous substances comprised therein and/or for malodor reduction and/or malodor coverage and/or malodor prevention.

Thus, the present invention relates in a further aspect to a method of treating a substrate, comprising the steps of:
treating the substrate with the detergent and/or cleaning composition or product according to the present invention; and
optionally rinsing said substrate in water to remove said composition or product.

Preferably, the method of threating a substrate takes place in a washing device or container containing a wash liquor comprising water and the detergent and/or cleaning composition or product according to the present invention. The wash liquor may be applied to the substrate, or the substrate may be immersed into the wash liquor.

The method may alternatively comprise direct application of the detergent and/or cleaning composition or product, i.e. undissolved without water on to part or whole of the substrate, so as to directly treat a substrate. Such a process is preferably a pre-treatment and may be followed by treatment with or within a wash liquor.

Surprisingly it turned out, that the detergent and/or cleaning composition according to the present invention is suitable for a broad range of fabrics or textiles made of cotton, wool, silk and synthetic fibers, such as polyester, polyacrylic, viscose, and the like and provides for an intense and long-lasting scent impression.

Preferably, the method is applied at low temperature. Preferably, the treatment temperature is less than 50 °C and preferably less than 40 °C and more preferably less than 30 °C.

Surprisingly it turned out, that the method according to the present invention is particularly efficient at said low temperatures.

Thus, the method allows for removal of soil and/or stain in a low temperature range, in particular for temperature sensitive fabrics or textiles, such as silk, wool, polyester, polyacrylic, viscose, and the like.

The use of the detergent and/or cleaning composition or product according to the present invention in the method according to the present invention provides for improved cleaning performance.

Based on the advantageously effects, the present invention relates in a further aspect to the use of a mixture (c) comprising or consisting of 1,2-heptanediol or 2,3-heptanediol or a mixture comprising 1,2-heptanediol and 2,3-heptanediol or
(c^{I}) at least one (fragrance) boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein;
and at least one further boosting agent selected from the group consisting of
(c^{II}) glyceryl caprylate;
(c^{II}) 4-hydroxyacetophenone;
(c^{IV}) ethyl hexyl glycerin; and
any mixture thereof;
for boosting the cleaning efficiency of a detergent and/or cleaning composition and/or for boosting the olfactory properties of odorous substances and/or for boosting the adherence of odorous substances and/or for malodor reduction and/or for malodor coverage and/or malodor prevention.

Based on the advantageously effects, the present invention relates in a further preferred aspect to the use of a mixture (c) comprising or consisting of:
(c^{I}) at least one (fragrance) boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein;
and at least one further boosting agent selected from the group consisting of
(c^{II}) glyceryl caprylate;
(c^{II}) 4-hydroxyacetophenone;
(c^{IV}) ethyl hexyl glycerin; and
any mixture of these further boosting agents;
for boosting the cleaning efficiency of a detergent and/or cleaning composition and/or for boosting the olfactory properties of odorous substances and/or for boosting the adherence of odorous substances and/or for malodor reduction and/or for malodor coverage and/or malodor prevention.

Preferably the alkanediols have a carbon chain of 7 to 14 carbon atoms and further preferred 7 to 12, and even more preferred 7 to 10 carbon atoms, and most preferred 7 to 9 carbon atoms.

With respect to the fragrance substance(s)/odorous substance(s) and preferred variants thereof, reference is made to the previous description of the odorous substance(s) in connection with the detergent and/or cleaning composition according to the present invention, which is equally valid in connection with the use of at least one (fragrance) boosting composition (c) for boosting the cleaning efficiency of a detergent and/or cleaning composition and/or for boosting the olfactory properties of odorous substances and/or for boosting the adherence of odorous substances and/or for malodor reduction and/or for malodor coverage.

Because of the boosting effect, the total amount of other additives in a detergent and/or cleaning composition can be reduced and the use of further fragrances and additives such as fixatives and the like can be almost eliminated or at least reduced while providing for an efficient detergent and/or cleaning composition providing for excellent cleaning performances and olfactory performances.

It was surprisingly found that the addition of an effective amount of a mixture (c)/use of alkanediols such as 1,2-heptanediol or 2,3-heptanediol or a mixture comprising 1,2-heptanediol and 2,3-heptanediol or at least one alkanediol as specified herein as boosting agents in combination with further boosting agents selected from the group consisting of glyceryl caprylate, 4-hydroxyacetophenone, and/or ethyl hexyl glycerin, as defined herein, to a detergent and/or cleaning composition, has a positive and synergistic influence on the cleaning performance and efficiently boosts the olfactory properties of odorous substances such as their intensity and/or improves the adherence of odorous substances comprised in the compositions. Simultaneously these substances allow for an efficient malodor reduction and/or malodor coverage or even the prevention of the formation of malodor. This superior effect is based on the synergistic combination of the odorous substance and the fragrance boosting composition. The improvement also allows for the reduction of fragrance compounds and their auxiliaries in a detergent and/or cleaning composition, while providing for a fresh, clean and hygienic odor impression underlining the efficient cleaning performance of the compositions as disclosed herein.

The present invention thus further relates to the use of a composition comprising at least one surfactant as component (a), at least one odorous substance as component (b), at least one fragrance boosting mixture (c) comprising a mixture of (c^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein and at least one further boosting agent selected from the group consisting of (c^{II}) glyceryl caprylate, (c^{II}) 4-hydroxyacetophenone, and/or (c^{IV}) ethyl hexyl glycerin, and optionally at least one antimicrobial compound as component (d), for boosting the cleaning efficiency of a detergent and/or cleaning composition and/or for boosting the olfactory properties of odorous substances and/or for boosting the adherence of odorous substances and/or for malodor reduction and/or for malodor coverage and/or malodor prevention.

Preferably the alkanediols used as the at least one (fragrance) boosting agent have a carbon chain of 7 to 14 carbon atoms and further preferred 7 to 12, and even more preferred 7 to 10 carbon atoms, and most preferred 7 to 9 carbon atoms.

Preferably, said composition is used in textile cleaning, laundry, fabric care, dishwashing, for household, institutional and industrial hard surface cleaning, cleaning medical and dental instruments.

Finally, based on the advantageously effects, the present invention also relates to a method of boosting the cleaning efficiency of a detergent and/or cleaning composition and/or boosting the olfactory properties of odorous substances and/or boosting the adherence of odorous substances and/or malodor reduction and/or malodor coverage and/or malodor prevention, comprising the steps of:
(i) providing a detergent and/or cleaning composition comprising at least one surfactant and at least one odorous substance; and
(ii) adding thereto an effective amount of a mixture (c) of 1,2-heptanediol or 2,3-heptanediol or a mixture comprising 1,2-heptanediol and 2,3-heptanediol or of
   (c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein;
   and at least one boosting agent selected from the group consisting of
   (c^{II}) glyceryl caprylate;
   (c^{II}) 4-hydroxyacetophenone;
   (c^{IV}) ethyl hexyl glycerin; and
   any mixture thereof.

Finally, based on the advantageously effects, the present invention also relates to a method of boosting the cleaning efficiency of a detergent and/or cleaning composition and/or boosting the olfactory properties of odorous substances and/or boosting the adherence of odorous substances and/or malodor reduction and/or malodor coverage and/or malodor prevention, comprising the steps of:
(i) providing a detergent and/or cleaning composition comprising at least one surfactant and at least one odorous substance; and
(ii) adding thereto an effective amount of a mixture (c) comprising or consisting of
   (c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein;
   and at least one boosting agent selected from the group consisting of
   (c^{II}) glyceryl caprylate;
   (c^{III}) 4-hydroxyacetophenone;
   (c^{IV}) ethyl hexyl glycerin; and
   any mixture of these further boosting agents.

With respect to the fragrance substance(s)/odorous substance(s) and preferred variants thereof, reference is made to the previous description of the odorous substance(s) in connection with the detergent and/or cleaning composition according to the present invention, which is equally valid in connection with the use of at least one fragrance boosting composition (or mixture) (c) for boosting the cleaning efficiency of a detergent and/or cleaning composition and/or for boosting the olfactory properties of odorous substances and/or for boosting the adherence of odorous substances and/or for malodor reduction and/or for malodor coverage and/or malodor prevention.

Preferably the alkanediols used as the at least one (fragrance) boosting agent have a carbon chain of 7 to 14 carbon atoms, and further preferred 7 to 12, and even more preferred 7 to 10 carbon atoms, and most preferred 7 to 9 carbon atoms.

Surprisingly, it has been found that the addition of an effective amount of a mixture of 1,2-heptanediol or 2,3-heptanediol or a mixture comprising 1,2-heptanediol and 2,3-heptanediol or other alkanediols as specified herein in combination with a further boosting agent selected from the group consisting of glyceryl caprylate, 4-hydroxyacetophenone, and/or ethyl hexyl glycerin, as defined herein, to a detergent and/or cleaning composition, has a positive influence in that they synergistically enhance the fragrance performance of an odorous substance or a mixture of odorous substances (perfume oil) comprised therein. The fragrance(s) in these detergent and/or cleaning compositions show(s) a distinguished intensity and adhesion, compared to detergent and/or cleaning compositions without such a fragrance boosting composition. In addition, the synergistic combination of the inventive (fragrance) boosting agents with an odorous substance or a mixture of odorous substances to an improved malodor reduction and/or for malodor coverage of the detergent and/or cleaning composition, compared to a detergent and/or cleaning composition without said mixtures of (fragrance) boosting agents.

Conversely, also because of the boosting effect, the amount of fragrances or other ingredients for increasing/improving the fragrance impression in these detergent and/or cleaning compositions can be reduced to achieve a similar odorous effect.

The present invention shall now be described in detail with reference to the following examples, which are merely illustrative of the present invention, such that the content of the present invention is not limited by or to the following examples.

### EXAMPLES

### Example 1

The following tests are performed to show the boosting effect of the boosting agents as specified herein in terms of cleaning performance and the improvement of fragrance intensity and the enhanced adherence of the fragrance substances on the corresponding substrate in a commercial liquid detergent and/or cleaning composition.

In parallel, comparative tests under the same conditions are carried out for corresponding compositions but without the inventive mixtures of a first boosting component with a further (second) boosting component as specified herein.

### Laundry Detergent

The cleaning performance for a laundry detergent is analyzed according to the standard A.I.S.E. (International Association for Soaps, Detergents and Maintenance Products) Laundry Detergent Testing Guidelines.

The cleaning performance test consists of assessing the stain removal efficiency of the tested laundry detergents on 14 stains.

Test conditions: Washing machine, Miele European Household front loader
Water hardness: 2.5 mmol/l
Water temperature: 40 °C.
Wash cycle: 6 cycles (Heavy-duty detergent: cotton cycle;
   light-duty detergent: delicate cycle)
Ballast load: 3 kg, clean white ballast load
Ballast soil: 4 SBL 2004 sheets (100% cotton, approx. 8 g soil/swatch)
Dosage: recommended dosage for normal soil/medium hardness
Drying: on a line over night
Stain sets: Tea, chocolate, coffee, grass, red wine, grass/mud, fruit juice, blood, tomato puree, unused motor oil, salad dressing balsamic, cooked beef fat, French squeezy mustard, and make-up.

The measurements/evaluation are taken on each stain before wash (to verify the quality of stains) and after the wash.

The evaluation of the degree of stain removal can either be assessed by
(A) Visually via a panel;
(B) Using a spectrophotometer, or digital image analysis system to determine the Stains Removal Index (SRI) whiteness degree W.

The sensory evaluation is used in order to determine the fragrance intensity as well as the malodor reduction. This sensory evaluation was performed by a trained panel.

Based on the spectroscopic or visual determination via a panel it is possible to determine the degree of stain removal and thus the cleaning performance.

The results are statistically treated using Tukey's HSD test (HSD=honestly significant difference) with 95% confidence level. The HSD value highlights the significant differences between each pair of products.

### Sensory Evaluation

The degree of malodor reduction or malodor coverage and/or fragrance intensity and/or fragrance adherence was subsequently tested and evaluated in an established setup with a trained panel.

For the evaluation of malodor coverage/reduction, a defined amount of the composition was applied on a filter paper together with a defined amount of sweat malodor. Alternatively, textile samples were treated with sweat malodor and subsequently washed with the detergent and/or cleaning compositions.

The fragrance intensity and adherence were rated based on a scale ranging from 1 (odorless) to 6 (very strong) or alternatively on a scale from 1 to 10 in a blind evaluation. Alternatively, for the evaluation of the malodor, the panelists were asked to rate the individual samples on a scale from 0 to 10 (0: odorless; 10: strongest imaginable). The cleaning performance was visually determined by a penal on a scale form 1 (no cleaning) to 10 (complete removal).

The results demonstrate that a composition comprising a surfactant, an odorous substance, an effective amount of a boosting mixture of 1,2-heptanediol and/or 2,3-heptanediol or of the alkanediols as specified herein with glyceryl caprylate, 4-hydroxyacetophenone, and/or ethyl hexyl glycerin is especially useful for malodor reduction and/or malodor coverage based on a synergistic malodor reduction/coverage effect.

Simultaneously the fragrance intensity of the odorous component is intensified in a synergistical manner. Moreover, the combination of alkanediols as boosting agents and further boosting agents selected from the group consisting of glyceryl caprylate, 4-hydroxyacetophenone, and/or ethyl hexyl glycerin result in a synergistically improved adherence of the fragrance components on the surfaces and textiles treated with the inventive composition.

Furthermore, the results show that alkanediol having a carbon chain of 7 to 14 carbon atoms result in particularly good fragrance boosting properties when combined with the further boosting agents selected from the group consisting of glyceryl caprylate, 4-hydroxyacetophenone, and/or ethyl hexyl glycerin compared to shorter chained alkanediols.

Finally, it was found that the combination of a first boosting component based on alkanediols with a further second boosting component selected from the group consisting of glyceryl caprylate, 4-hydroxyacetophenone, and/or ethyl hexyl glycerin shows excellent fragrance boosting properties in terms of an improved fragrance intensity and adherence.

Simultaneously, these combinations of boosting agents allow for an efficient malodor reduction/coverage/prevention. Surprisingly, these advantageous properties are more pronounced for the combination of the first boosting agent and the further second boosting agent compared to the single substances (i.e. alkanediols, glyceryl caprylate, 4-hydroxyacetophenone, and/or ethyl hexyl glycerin alone). This indicates a synergistic interaction between the alkanediol component and the further boosting component as specified herein.

Additionally, similar experiments were performed in order to show the anti-yellowing and cleaning properties of the present invention.

### Formulation Examples

TABLE F1
Fabric softener

| No | Ingredients | Amount (%) |
|---|---|---|
| 1 | Di-(Talg Carboxyethyl) Hydroxyethyl | 5.5 |
| | methylammonium-methosulfate | |
| 2 | Simethicone | 0.3 |
| 3 | 2-Octyl-2H-isothiazol-3-one | 0.1 |
| 4 | 1,2-Heptanediol | 0.5 |
| 5 | Fragrance | 0.2 |
| 6 | Cellulase | 0.3 |
| 7 | 4-Hydroxyacetophenone | 0.5 |
| 8 | Aqua | add 100 |

TABLE F2
Fabric softener concentrate, encapsulated

| No | Ingredients | Amount (%) |
|---|---|---|
| 1 | Di-(Talg Carboxyethyl) Hydroxyethyl | 16.6 |
| | methylammonium-methosulfate | |
| 2 | 2-Octyl-2H-isothiazol-3-one | 0.1 |
| 3 | Simethicone | 0.3 |
| 4 | Magnesium chloride | 0.8 |
| 5 | Encapsulated perfume oil | 0.3 |
| 6 | Crosslinked cationic polymer | 0.15 |
| 7 | 1,2-Heptanediol | 0.5 |
| 8 | Fragrance | 0.6 |
| 9 | Cellulase | 0.5 |
| 10 | Ethyl hexyl glycerin | 0.7 |
| 11 | Aqua | add 100 |

TABLE F3
Fabric softener concentrate, encapsulated

| No | Ingredients | Amount (%) |
|---|---|---|
| 1 | Di-(Talg Carboxyethyl) Hydroxyethyl | 16.6 |
| | methylammonium-methosulfate | |
| 2 | 2-octyl-2H-isothiazol-3-one | 0.1 |
| 3 | Simethicone | 0.3 |
| 4 | Magnesium chloride | 0.8 |
| 5 | Encapsulated perfume oil | 0.3 |
| 6 | Crosslinked cationic polymer | 0.15 |
| 7 | 2,3-Heptanediol | 0.05 |
| 8 | 1,2-Heptanediol | 0.5 |
| 9 | Fragrance | 0.6 |
| 10 | Cellulase | 0.5 |
| 11 | Glyceryl caprylate; | 0.5 |
| 12 | Aqua | add 100 |

TABLE F4
Detergent liquid, light duty

| No | Ingredients | Amount (%) |
|---|---|---|
| 1 | Cocos fatty acid | 0.85 |
| 2 | Potassium hydroxide | 0.45 |
| 3 | 2-Octyl-2H-isothiazol-3-one | 0.2 |
| 4 | Sulfonic acid, C 13-17-sec-Alkyl-, Sodium salt | 20 |
| 5 | Sodium Laureth Sulfate | 3 |
| 6 | Trideceth-9 | 5 |
| 7 | Sodium Chloride | 1.3 |
| 8 | 2,3-Octanediol | 0.1 |
| 9 | 1,2-Heptanediol | 0.9 |
| 10 | Fragrance | 0.5 |
| 11 | Protease (Subtilisin) | 0.6 |
| 12 | Amylase | 0.3 |
| 13 | 4-Hydroxyacetophenone | 0.6 |
| 14 | Aqua | add to 100 |

TABLE F6
Detergent liquid, light duty

| No | Ingredients | Amount (%) |
|---|---|---|
| 1 | Cocos fatty acid | 0.85 |
| 2 | Potassium hydroxide | 0.45 |
| 3 | 2-Octyl-2H-isothiazol-3-one | 0.2 |
| 4 | Sulfonic acid, C 13-17-sec-Alkyl-, Sodium salt | 20 |
| 5 | Sodium Laureth Sulfate | 3 |
| 6 | Trideceth-9 | 5 |
| 7 | Sodium Chloride | 1.3 |
| 8 | 2,3-Heptanediol | 0.1 |
| 9 | 1,2-Heptanediol | 0.9 |
| 10 | Fragrance | 0.5 |
| 11 | Protease (Subtilisin) | 0.5 |
| 12 | Ethyl hexyl glycerin | 0.5 |
| 13 | Aqua | add to 100 |

TABLE F7
Laundry pre-spotter (use before wash)

| No | Ingredients | Amount (%) |
|---|---|---|
| 1 | Hydrogen peroxide | 10.5 |
| 2 | C12-14 PARETH-7 | 2.4 |
| 3 | Sulfonic acid, C 13-17-sec-Alkyl-, Sodium salt | 2.3 |
| 4 | Etidronic Acid | 0.7 |
| 5 | 2,3-Heptanediol | 0.1 |
| 6 | 1,2-Heptanediol | 0.9 |
| 7 | Fragrance | 0.4 |
| 8 | 4-Hydroxyacetophenone | 0.6 |
| 9 | Aqua | add to 100 |

TABLE F8
Laundry pre-spotter (use before wash)

| No | Ingredients | Amount (%) |
|---|---|---|
| 1 | Hydrogen peroxide | 10.5 |
| 2 | C12-14 PARETH-7 | 2.4 |
| 3 | Sulfonic acid, C 13-17-sec-Alkyl-, Sodium salt | 2.3 |
| 4 | Tetrasodium Imino disuccinate | 0.8 |
| 5 | 1,2-Heptanediol | 1 |
| 6 | Fragrance | 0.4 |
| 7 | Ethyl hexyl glycerin | 0.7 |
| 8 | Aqua | add to 100 |

TABLE F9
Laundry powder

| No | Ingredients | Amount (%) |
|---|---|---|
| 1 | Sodium sulfate | add to 100 |
| 2 | Sodium chloride | 18 |
| 3 | Sodium percarbonate (Sodium carbonate peroxide) | 15 |
| 4 | Sodium carbonate | 10 |
| 5 | Sodium C10-13 Alkyl Benzenesulfonate | 9 |
| 6 | Sodium silicate | 9 |
| 7 | Zeolite | 7 |
| 8 | TAED | 3 |
| 9 | Cellulose | 2.2 |
| 10 | Tetrasodium Etidronate | 2 |
| 11 | MGDA | 1.7 |
| 12 | C12-14 Pareth-n | 1.5 |
| 13 | Sodium Soap C16-C18 Palm | 0.8 |
| 14 | Disodium 2,2′-([1,1′-biphenyl]-4,4′- | 0.6 |
| | diyldivinylene)bis(benzenesulphonate) | |
| 15 | 1,2-Heptanediol | 0.9 |
| 16 | Fragrance | 0.4 |
| 17 | Protease | 1.5 |
| 18 | Amylase | 0.6 |
| 19 | Lipase | 0.2 |
| 20 | Mannanase | 0.1 |
| 21 | Pectate lyase | 0.1 |
| 22 | Benzotriazole | 0.3 |
| 23 | 4-Hydroxyacetophenone | 0.8 |

TABLE F10
Automatic dishwashing tablet (ADW tablet)

| No | Ingredients | Amount (%) |
|---|---|---|
| 1 | Sodium carbonate | add to 100 |
| 2 | Sodium citrate | 15 |
| 3 | MGDA | 15 |
| 4 | Sodium percarbonate (Sodium carbonate peroxide) | 13 |
| 5 | Fatty alcohol polyglycolether | 4 |
| 6 | Polyacrylate sulphonated copolymer | 4 |
| 7 | Polyethylene glycol (MW 400-MW 8000) | 3 |
| 8 | Sodium sulphate | 5 |
| 9 | Sodium silicate | 5 |
| 10 | Zeolite | 4 |
| 11 | TAED | 2 |
| 12 | Cellulose | 1 |
| 13 | Tetrasodium Etidronate | 2 |
| 18 | 1,2-Heptanediol | 0.9 |
| 19 | Fragrance | 0.4 |
| 20 | Mn-TACN | 0.04 |
| 21 | Protease | 1.7 |
| 22 | Amylase | 0.7 |
| 23 | Benzotriazole | 0.3 |
| 24 | 4-Hydroxyacetophenone | 0.7 |

1. A detergent and/or cleaning composition, comprising or consisting of
(a) at least one surfactant;
(b) at least one odorous substance;
(c) a mixture comprising or consisting of
(c^{I}) at least one boosting agent selected from the group consisting of at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
and at least one further boosting agent selected from the group consisting of
(c^{II}) glyceryl caprylate;
(c^{III}) 4-hydroxyacetophenone;
(c^{IV}) ethyl hexyl glycerin; and
any mixtures of these further boosting agents; and
(d) optionally at least one antimicrobial compound.

2. The detergent and/or cleaning composition according to claim 1, wherein the at least one surfactant is selected from the group consisting of nonionic surfactants, anionic surfactants, amphoteric surfactants/zwitterionic surfactants, cationic surfactants, and any mixtures thereof, preferably comprising the at least one surfactant in an amount of 0.001% to 90% by weight, preferred in an amount of 0.001% to 60% by weight, more preferred in an amount of 0.01% to 50% by weight, most preferred in an amount of 0.1% to 40% by weight, based on the total weight of the composition.

3. The detergent and/or cleaning composition according to claim 2, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols such as
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxides;
C10 to C18 N-(alkyl)-N,N-bis(2-hydroxyethyl) amine oxides;
C10 to C18 alkyl amido propyl dimethyl amine oxides;
C10 to C18 alkylbetaines;
C10 to C18 alkylamidobetaines;
C10 to C18 sulfobetaines;
and any mixture thereof;
and any mixture of the above specified cationic, anionic, non-ionic and amphoteric/zwitterionic surfactants.

4. The detergent and/or cleaning composition according to claim 1, wherein the at least one odorous substance is selected from the group consisting of esters, ethers, aldehydes, ketones, alcohols and hydrocarbons, or any mixture thereof, preferably comprising the at least one odorous substance in an amount of 0.00001% to 10% by weight, preferred in an amount of 0.0001% to 5% by weight, and most preferred in an amount of 0.001% to 2% by weight, based on the total weight of the composition.

5. The detergent and/or cleaning composition according to claim 1, wherein the at least one linear alkanediol or the at least one first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof and/or
the one or more second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

6. The detergent and/or cleaning composition according to claim 5, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof or
wherein the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof,
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol;
a mixture comprising 1,2-tetradecanediol and 2,3-tetradecanediol;
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol; and
a mixture comprising 1,2-heptanediol and 2,3-nonanediol.

7. The detergent and/or cleaning composition according to claim 1,
wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

8. The detergent and/or cleaning composition according to claim 1, wherein the at least one antimicrobial compound is selected from the group consisting of benzyl alcohol, methylbenzyl alcohol, phenoxyethanol, and any mixture thereof, preferably comprising the at least one antimicrobial compound in an amount of 0.0001% to 15.0% by weight, particularly in an amount of 0.001% to 10.0% by weight, most particularly in an amount of 0.001% to 5.0% by weight, based on the total weight of the composition.

9. The detergent and/or cleaning composition according to claim 1, further comprising at least one enzyme, preferably wherein the at least one enzyme is selected from the group consisting of protease, lipase, amylase, cellulase, cutinase, gluconase, peroxidase, pectinase, mannanase, esterase, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, β-glucanases, arabinosidases, hyaluronidases, chondroitinase, oxidoreductases, and any mixtures thereof, and optionally further comprising at least one enzyme stabilizing agent.

10. The detergent and/or cleaning composition according to claim 1, comprising a mixture of the at least one boosting agent (c^{I}) and the at least one further boosting agent selected from the group consisting of (c^{II}), (c^{III}), (c^{IV}), and any mixtures of these further boosting agents, in an amount of 0.001% to 15.0% by weight, preferred in an amount of 0.01% to 10.0% by weight, more preferred in an amount of 0.1% to 5.0% by weight, still more preferred in an amount of 0.3 to 3.0% by weight, most preferred in an amount of 0.5% to 1.0% by weight, based on the total weight of the composition.

11. The detergent and/or cleaning composition according to claim 1, further comprising at least one active substance and/or additive selected from the group consisting of:
an anti-static agents, anti-wrinkling agents, antimicrobial agents, dye transfer inhibition agents/color protection agents, dye scavengers, dyes/coloring agents, greying inhibitors, odor removal/odor capturing agents, soil shielding/soil releasing agents, anti-redeposition agents, ultraviolet light protection agents, sanitizing agents, disinfecting agents, water repellency agents, insect repellency agents, anti-pilling agents, souring agents, mildew removing agents, allergicide agents, solubility modifiers, rheology modifiers/viscosity modifiers or thickeners, dispersing agents, water softeners, buffers, solvents, defoamers/foam inhibitors/suds suppressor, foam stabilizers, fabric softeners, starch agents, bleaching agents, bleach activators, bleach catalysts and bleach stabilizers, bleach scavengers, optical brighteners and ultraviolet light adsorbers, chelating agents/sequestrant agents, builders, co-builders, pH adjusters, stabilizers, hydrotropes, preservatives, fire proofing agents, shrinkage controllers, salts, and any mixtures thereof.

12. A detergent and/or cleaning product comprising the detergent and/or cleaning composition according to claim 1, for textile cleaning, laundry, fabric care, dishwashing, for household, institutional and industrial hard surface cleaning, cleaning of medical and dental instruments.

13. (canceled)

14. The detergent and/or cleaning product according to claim 12, preferably wherein the detergent and/or cleaning product is a heavy-duty detergent, color-care detergent, light duty detergent, all-purpose washing agent, fabric softener, fabric laundry scent, scent lotion, laundry wipe, stain remover, washing machine cleaner, homecare products, all-purpose cleaner, hand dishwashing detergent, auto dishwashing detergent, hard surface cleaner, glass and mirror cleaner, wet cleaning wipe, kitchen cleaner, cleaner for cooking appliances, oven cleaner, floor cleaner, wood floor cleaner, carpet cleaner, bathroom and shower cleaner, toilet cleaner, grout cleaner, disinfectant, drain unblocker, toilet rim block gel, air fresheners, furniture polish, car shampoo, medical cleaning products, all of the aforementioned products in liquid, solid, gelled, bar, paste, spray, tablet, encapsulated, diluted or concentrated form and optionally in two-compartment or multi-compartment form; and all of the aforementioned products for household, medical, institutional, or industrial applications.

15. A method of boosting the cleaning efficiency of a detergent and/or cleaning composition and/or boosting the olfactory properties of odorous substances comprised in a detergent and/or cleaning composition and/or boosting the adherence of odorous substances and/or malodor reduction and/or malodor coverage and/or for malodor prevention, comprising the steps of
(i) providing a detergent and/or cleaning composition comprising at least one surfactant and at least one odorous substance; and
(ii) adding an effective amount of a mixture (c) comprising or consisting of
(c^{I}) at least one boosting agent selected from the group consisting of at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined in claim 1; and
at least one further boosting agent selected from the group consisting of
(c^{II}) glyceryl caprylate;
(c^{III}) 4-hydroxyacetophenone;
(c^{IV}) ethyl hexyl glycerin; and
any mixture of these further boosting agents.
